(19) United States
(12) Patent Application Publication
(10) Pub. No.: US 2026/0043758 A1
(43) Pub. Date: Feb. 12, 2026

(54) BACKSCATTER X-RAY SYSTEM AND METHOD

(71) Applicant: The Boeing Company, Arlington, VA (US)

(72) Inventors: Charles E. Barnes, Glen Mills, PA (US); Matthew A. Carney, Broomall, PA (US)

(21) Appl. No.: 18/798,521

(22) Filed: Aug. 8, 2024

(51) Int. Cl. G01N 23/203; G01N 23/20008

(52) U.S. Cl. CPC G01N 23/203; G01N 23/20008; G01N 2223/3303; G01N 2223/629; G01N 2223/646

(57) ABSTRACT

A backscatter x-ray system has an x-ray device, a movable platform, and a processor. The x-ray device includes an x-ray emitter and an x-ray detector. The movable platform positions the x-ray device relative to a frontside of a structure. The processor is communicatively couplable to the x-ray device. The x-ray emitter emits x-rays that penetrate the structure from the frontside. The x-ray detector detects a backscatter of the x-rays reflected from the structure. The processor generates x-ray images of the structure based on the backscatter, and analyzes the x-ray images in a manner facilitating at least one of manufacturing and inspection of the structure.

### FIELD

The present disclosure relates generally to inspection systems and, more particularly, to the use of backscatter x-ray technology to facilitate the manufacturing and/or inspection of various aspects of a structure.

### BACKGROUND

The manufacturing of a commercial aircraft typically involves the installation of thousands of mechanical fasteners for joining the components that form the major structures of the aircraft. For example, a wing of a large transport aircraft can have in excess of 10,000 fasteners. The geometry of some structures, such as a wing, necessitates the installation of one-sided fasteners. For example, one-side fasteners must typically be installed in locations on the wing where only the frontside is accessible and the backside is generally inaccessible, such as in a fuel tank of a wing. Composi-Lok™ fasteners are a type of one-sided fastener having a pin that is inserted into a fastener hole from the frontside of a structure. The pin has an expandable sleeve that deforms into a bulb shape when compressed against the backside as the fastener is tightened.

Known methods for inspecting the installation of one-sided fasteners such as Composi-Lok™ fasteners include inserting an optical instrument such as a borescope into an open fastener hole, and visually inspecting the tail end of a fastener installation for proper formation. In the example of a Composi-Lok™ fastener, a technician looks through an eyepiece of the borescope to view the backside of the structure to determine if the sleeve bulb is properly formed and/or if an appropriate length of the pin protrudes from the sleeve bulb. Unfortunately, the size of some borescopes prevents insertion into relatively small fastener holes. In addition, some borescopes have focal length limitations that reduce the resolution at which the backside of the fastener installation can be viewed.

Another known method for inspecting the installation of one-sided fasteners involves a technician physically entering the structure to view the backside. For example, the inspection of fastener installations in a wing fuel tank can involve the removal of an access panel on the lower skin panel of the wing, after which a technician physically enters the wing through an access panel opening and crawls through the fuel tank to visually inspect each fastener installation. For relatively small structures, physical entry may be difficult. For structures having a large quantity of one-side fasteners, crawling through the wing and inspecting each fastener installation is time consuming.

As can be seen, there exists a need in the art for a system and method of inspecting the backside of one-sided fastener installations that does not require the insertion of optical instruments or the physical entry of a technician into the interior of a structure. Preferably the system and method facilitates the manufacturing and/or inspection of other aspects of the structure, and is not limited to inspecting fastener installations.

### SUMMARY

The above-noted needs associated with inspecting one-sided fastener installations and performing other tasks are addressed by the present disclosure, which provides a backscatter x-ray system having an x-ray device, a movable platform, and a processor. The x-ray device includes an x-ray emitter and an x-ray detector. The movable platform positions the x-ray device relative to a frontside of a structure. The processor is communicatively couplable to the x-ray device. The x-ray emitter emits x-rays that penetrate the structure from the frontside. The x-ray detector detects a backscatter of the x-rays reflected from the structure. The processor generates x-ray images of the structure based on the backscatter, and analyzes the x-ray images in a manner facilitating at least one of manufacturing and inspection of the structure.

Also disclosed is a backscatter x-ray system comprising an end effector frame configured to be mounted to a movable platform capable of positioning the end effector relative to a frontside of a structure. In addition, the backscatter x-ray system has a plurality of process tools mountable to the end effector frame and having different functional capabilities associated with hole formation and fastener installation in the structure. The backscatter x-ray system includes an x-ray device mountable to the end effector frame at a location adjacent to the process tools. The x-ray device is configured to emit x-rays that penetrate the structure from the frontside, and detect a backscatter of the x-rays reflected back from the structure. Furthermore, the backscatter x-ray system includes a processor configured to generate x-ray images based on the backscatter, and analyze the x-ray images in a manner detecting non-conformances in one or more aspects of at least one of a fastener hole, and a fastener installation in the fastener hole.

Also disclosed is a method of facilitating at least one of manufacturing and inspection of a structure. The method includes positioning, using a movable platform, an x-ray device relative to a frontside of a structure, and the x-ray device has an x-ray emitter and an x-ray detector. The method also includes emitting, using the x-ray emitter, x-rays that penetrate the structure from the frontside. The method additionally includes detecting, using the x-ray detector, a backscatter of the x-rays reflected from the structure. The method further includes generating, using a processor, x-ray images of the structure based on the backscatter. In addition, the method includes analyzing, using the processor, the x-ray images in a manner facilitating at least one of manufacturing and inspection of the structure.

The features, functions, and advantages that have been discussed can be achieved independently in various versions of the disclosure or may be combined in yet other versions, further details of which can be seen with reference to the following description and drawings.

### BRIEF DESCRIPTION OF THE DRAWINGS

The disclosure can be better understood with reference to the following detailed description taken in conjunction with the accompanying drawings, which illustrate preferred and exemplary versions, but which are not necessarily drawn to scale. The drawings are examples and not meant as limitations on the description or the claims.

FIG. 1 is a perspective view of an example of an aircraft;

FIG. 2 is an exploded view of a wing box of the aircraft of FIG. 1;

FIG. 3 is a perspective view of the wing box in an assembled state and supported by an assembly fixture and illustrating an example of a robotic device for positioning a backscatter x-ray device relative to the wing box for emitting x-rays from the frontside of the structure and detecting a backscatter of the x-rays reflected back from the structure;

FIG. 4 is a side view taken along line 4-4 of FIG. 3, and illustrating the robotic device positioning the x-ray device relative to the wing box;

FIG. 5 is a perspective view of an example of the x-ray device of FIG. 4 inspecting a fastener installation in a structure, and the x-ray device is comprised of an x-ray emitter emitting an x-ray beam comprised of x-rays that penetrate the frontside of the structure, and an x-ray detector detecting the backscatter of the x-rays reflected from the structure;

FIG. 6 is a top-down view of the x-ray device of FIG. 5 illustrating the backscatter of x-rays reflecting off the surfaces of the one-sided fastener;

FIG. 7 is a partial sectional view of an example of a one-sided fastener for installation in locations of a structure where the backside is not readily accessible;

FIG. 8 is a sectional view of the one-sided fastener installed in a structure, and illustrating a sleeve bulb that is formed against the backside of the structure when the fastener body is rotated from the frontside, and further illustrating x-ray images emitted by the x-ray emitter of the x-ray device, and the backscatter of x-rays for detection by an x-ray detector of the x-ray device;

FIG. 9 shows an example of a computer display screen displaying an x-ray image of the fastener installation of FIG. 8 as generated by the x-ray device, and also displaying a reference image of a fastener installation to which the x-ray image is compared for detecting potential non-conformances in the sleeve bulb and/or other aspects of the fastener installation;

FIG. 10 shows an example of the use of the x-ray device for inspecting the installation of a two-part fastener;

FIG. 11 shows an example of the use of the x-ray device for inspecting a sealant installation on a backside of the structure;

FIG. 12 shows an example of the use of the x-ray device to monitor in real time the formation of a welding bead on the structure;

FIG. 13 shows an example of the use of the x-ray device for inspecting a backside of a structural assembly;

FIG. 14 shows an example of the use of multiple x-ray devices, including one x-ray device in which the beam central axis is oriented parallel to the fastener centerline of the fastener installation in the structure, and another x-ray device in which the beam central axis is oriented non-parallel to the fastener centerline;

FIG. 15 shows an example of an x-ray device in which the beam central axis of the x-ray beam is oriented non-parallel to the fastener centerline for detecting a head-to-structure gap between the fastener head and the structure;

FIG. 16 is a magnified view of the fastener installation of FIG. 15;

FIG. 17 shows a computer display screen displaying an x-ray image of the fastener installation of FIG. 16 as generated by the x-ray device, and also displaying a reference image of the fastener installation to which the x-ray image is compared for detecting the gap between the fastener head and the structure;

FIG. 18 shows an example of the use of the x-ray device for inspecting the structure for the presence of shims in the material stackup of the structure;

FIG. 19 shows an example of the use of the x-ray device for inspecting the structure for the presence of a doubler on the backside of the structure;

FIG. 20 shows an example of the use of the x-ray device for inspecting a composite structure for the presence of interlaminar counterbores;

FIG. 21 shows an example of the use of the x-ray device for inspecting a structure for the presence of gashes and other damage to the backside of the structure;

FIG. 22 shows an example of the use of the x-ray device for inspecting a composite structure for porosity and/or voids;

FIG. 23 is a magnified view of the portion of the composite structure identified by reference numeral 23 of FIG. 22;

FIG. 24 shows an example of an x-ray device integrated into a computer numerical control (CNC) machine;

FIG. 25 is a side view of the CNC machine of FIG. 24;

FIG. 26 is a perspective view of the x-ray device of FIG. 25;

FIG. 27 is a top-down view of the x-ray device of FIG. 26;

FIG. 28 is a top-down perspective view of an example of a multi-function end effector (MFEE) having a plurality of different process tools each having different functional capabilities associated with hole formation and fastener installation in the structure, and the plurality of process tools include an x-ray device;

FIG. 29 is a bottom-up perspective view of the MFEE of FIG. 28 and showing each of the process tools supported by a tool carrier that is movable along a shuttle axis for one-at-a-time engagement of each process tool with the structure;

FIG. 30 is a top-down perspective view of the example of the x-ray device included with the process tools of the MFEE of FIGS. 28-29;

FIG. 31 is a top-down view of the end effector of FIGS. 28-29 and showing an example of a process tool configured as a spindle for rotatably driving a drill bit for forming a fastener hole in the structure;

FIG. 32 is a magnified view of the portion of the end effector and spindle identified by reference numeral 32 of FIG. 32, and illustrating the drill bit forming a countersunk hole in the structure;

FIG. 33 shows an example of a process tool configured as a hole probe for measuring at least one characteristic associated with a fastener hole formed in the structure by the drill bit;

FIG. 34 is a magnified view of the portion of the end effector and the hole probe identified by reference numeral 34 of FIG. 33;

FIG. 35 shows an example of a process tool configured as a fastener installer for installing a fastener in the fastener hole formed in the structure by the drill bit;

FIG. 36 is a magnified view of the portion of the end effector and the fastener installer identified by reference numeral 36 of FIG. 35;

FIG. 37 shows an example of a process tool configured as the x-ray device for inspecting the fastener installed by the fastener installer;

FIG. 38 is a magnified view of the portion of the end effector and the x-ray device identified by reference numeral 38 of FIG. 37;

FIG. 39 is a bottom-up perspective view of an MFEE having an x-ray device mounted in an off-angle orientation for monitoring operations performed on the structure by the process tools;

FIG. 40 is a side view of the MFEE of FIG. 40 showing the x-ray device monitoring the process of forming a fastener hole via the drill bit;

FIG. 41 is a magnified view of the drill bit forming a fastener hole in the structure, and further illustrating the x-ray device emitting x-ray beams and receiving the backscatter reflected off the structure;

FIG. 42 is a side view of an example of a welding device supported by a robotic arm, and further illustrating two x-ray devices mounted in an off-angle orientation relative to the welding device for monitoring the formation of a welding bead;

FIG. 43 is a magnified view of the welding device during formation of the welding bead on the structure;

FIG. 44 is a side view of an example of a surfacing device supported by a robotic arm, and further illustrating an x-ray device mounted in an off-angle orientation relative to the surfacing device for monitoring a surfacing operation performed on the frontside of the structure by the surfacing device;

FIG. 45 is a magnified view of the surfacing device removing material from the frontside of the structure while monitored by the x-ray device;

FIG. 46 is a side view of an example of a coating applicator supported by a robotic arm, and further illustrating an x-ray device mounted in an off-angle orientation relative to the coating applicator for monitoring the application of a coating on the frontside of the structure;

FIG. 47 is a magnified view of the coating applicator applying a coating to the frontside of the structure while monitored by the x-ray device;

FIG. 48 is a perspective view of a substructure (e.g., spars and wing ribs) of a wing box wing box supported by an assembly fixture during the loading of a skin panel onto the substructure;

FIG. 49 is a magnified view of a portion of the substructure of FIG. 48 illustrating vision points (e.g., pilot holes, part edges, etc.) formed in the substructure of the wing box for aligning the skin panel to the substructure;

FIG. 50 shows an example of an MFEE supported by a robotic device and including an x-ray device for detecting vision points (e.g., pilot holes) in the substructure for positioning the MFEE relative to the wing box;

FIG. 51 is a magnified view of the x-ray device acquiring a vision point located in the substructure behind the skin panel;

FIG. 52 is a side view of the MFEE of FIGS. 50-51 and showing a spindle and drill bit aligned with the vision point detected by the x-ray device;

FIG. 53 is a magnified view of the MFEE showing the x-ray device acquiring the vision point in the substructure;

FIG. 54 shows an example of an MFEE supported by a frontside robot on a frontside of a structure, and further illustrating a backside robot supporting a backside process tool located on a backside of the structure for performing an operation in cooperation with one or more process tools of the MFEE on the frontside;

FIG. 55 is a perspective view of an example of the MFEE on the frontside of the structure and including an x-ray device incorporated into the spindle of the MFEE;

FIG. 56 shows an example of the x-ray device incorporated into the spindle;

FIG. 57 is a side view of the structure of FIG. 54 showing the MFEE on the frontside aligned with the backside process tool;

FIG. 58 is a magnified view of the structure of FIG. 57 showing the x-ray device on the frontside of the structure detecting the location of the backside process tool for aligning the spindle with the backside process tool; and

FIG. 59 is a flowchart of operations included in a method of at least one of manufacturing and inspecting a structure.

The figures shown in this disclosure represent various aspects of the versions presented, and only differences will be discussed in detail.

### DETAILED DESCRIPTION

Disclosed versions will now be described more fully hereinafter with reference to the accompanying drawings, in which some, but not all of the disclosed versions are shown. Indeed, several different versions may be provided and should not be construed as limited to the versions set forth herein. Rather, these versions are provided so that this disclosure will be thorough and fully convey the scope of the disclosure to those skilled in the art.

This specification includes references to “one configuration” or “a configuration. ” Instances of the phrases “one configuration” or “a configuration” do not necessarily refer to the same configuration. Similarly, this specification includes references to “one example” or “an example. ” Instances of the phrases “one example” or “an example” do not necessarily refer to the same example. Particular features, structures 320, or characteristics may be combined in any suitable manner consistent with this disclosure.

As used herein, “comprising” is an open-ended term, and as used in the claims, this term does not foreclose additional structures 320 or steps.

As used herein, “configured to” means various parts or components may be described or claimed as “configured to” perform a task or tasks. In such contexts, “configured to” is used to connote structure 320 by indicating that the parts or components include structure 320 that performs those task or tasks during operation. As such, the parts or components can be said to be configured to perform the task even when the specified part or component is not currently operational (e.g., is not on).

As used herein, the terms “first”, “second”, etc., are used as labels for nouns that they precede, and do not imply any type of ordering (e.g., spatial, temporal, logical, etc.).

As used herein, an element or step recited in the singular and preceded by the word “a” or “an” should be understood as not necessarily excluding the plural of the elements or steps. As used herein, the term “and/or” includes any and all combinations of one or more of the associated listed items. As also used herein, the term “combinations thereof” includes combinations having at least one of the associated listed items, wherein the combination can further include additional, like non-listed items.

As used herein, the phrase “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

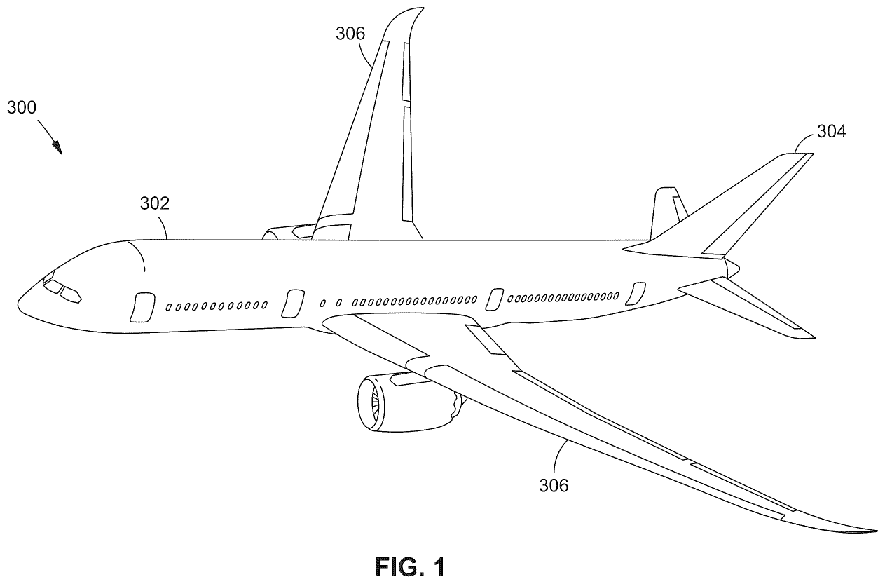

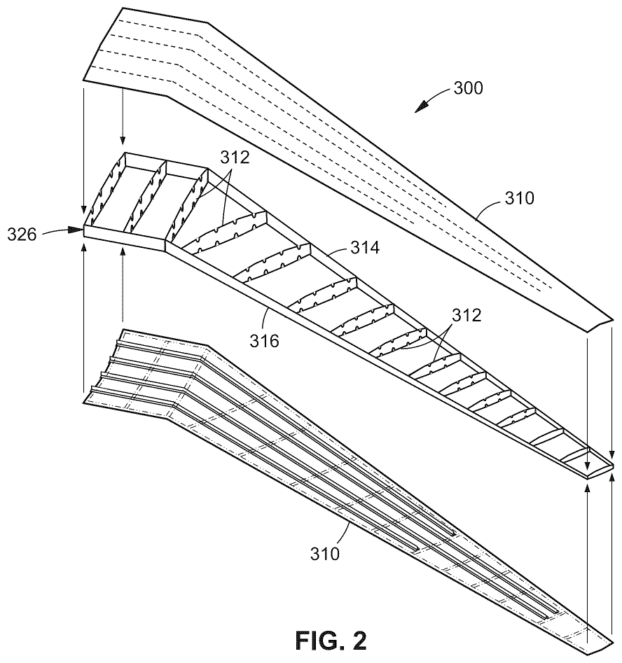

Referring now to the drawings which illustrate various examples of the disclosure, shown in FIG. 1 is an aircraft 300 having a fuselage 302, a tail section 304, and a pair of wings 306. FIG. 2 is an exploded view of an example of a wing box 308, which is typically the primary load-carrying component of an aircraft wing 306. The wing box 308 includes a substructure 326 comprised of a front spar 314, a rear spar 316, and a plurality of wing ribs 312, each extending between the front spar 314 and the rear spar 316. Skin panels 310 are positioned on opposite sides of the substructure 326 of the wing box 308. The skin panels 310 are typically fastened to the front spar 314, rear spar 316 and wing ribs 312 via a plurality of mechanical fasteners 400 (e.g., FIG. 8).

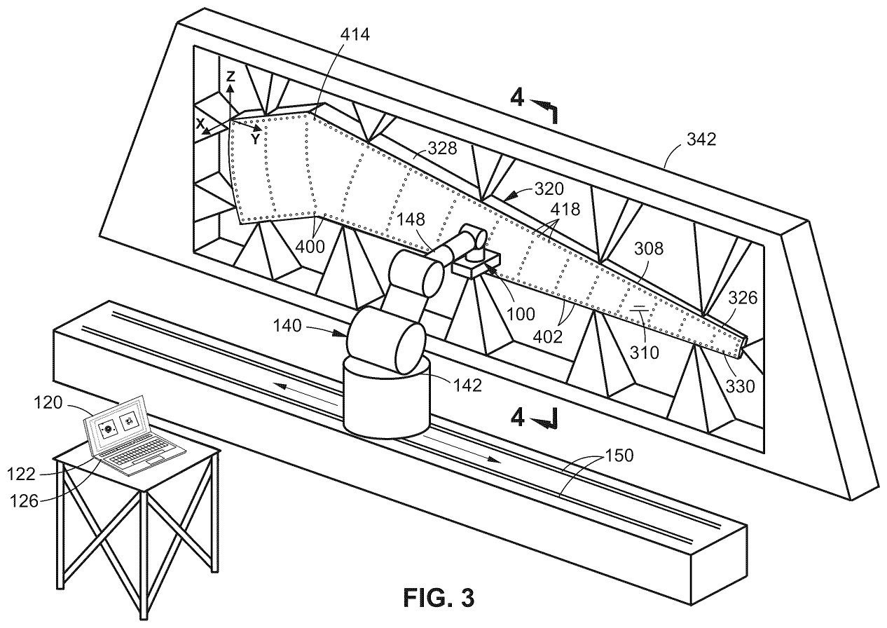

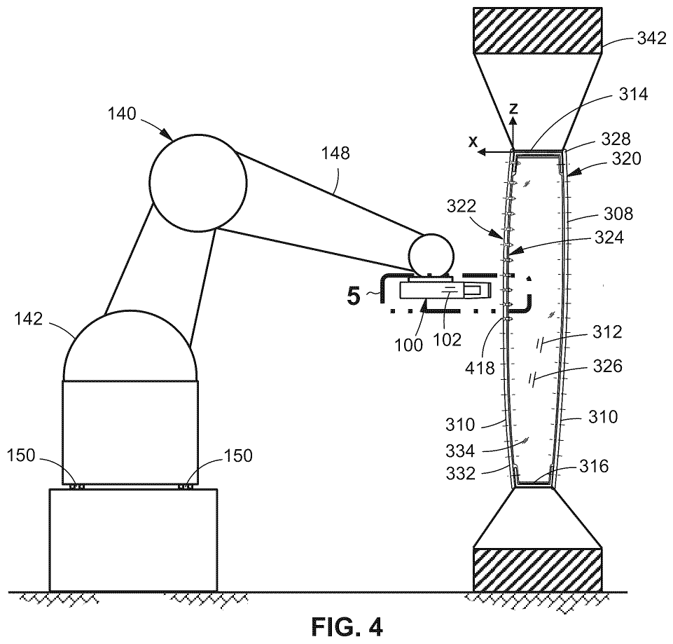

Referring to FIGS. 3-4, shown is an example of the presently disclosed backscatter x-ray system 100. The backscatter x-ray system 100 has an x-ray device 102 configured to be operated in an automated manner (i.e., without human intervention) to facilitate the manufacturing and/or inspection of a structure 320, such as the structural assembly 328 exemplified by the wing box 308 of FIG. 2. In FIGS. 3-4, the wing box 308 is supported by an assembly fixture 342 to facilitate the fastening of the skin panels 310 to the substructure 326, comprised of the front spar 314, rear spar 316, and wing ribs 312. When both skin panels 310 are positioned against the substructure 326, access to the interior of the wing box 308 is limited or prevented, which necessitates the use of one-sided fasteners 418 (e.g., blind fasteners) that are installed from the frontside 322 of the wing box 308.

In addition to the x-ray device 102, the backscatter x-ray system 100 includes a movable platform 140 configured to position and/or orient the x-ray device 102 relative to the frontside 322 (e.g., a first side) of a structure 320. In some examples, the movable platform 140 can move the x-ray device 102 along a fastener pattern 414 in a structure 320, stopping at each location of the fastener pattern 414 to form a fastener hole 402, inspect the fastener hole 402, install a fastener 400 in the fastener hole 402, and inspect the fastener 400 for proper installation.

In the present disclosure, the frontside 322 of a structure 320 is an exterior side of the structure 320 and/or a readily accessible side of the structure 320. Alternatively or additionally, the frontside 322 is the side of the structure 320 on which the x-ray device 102 is located. The structure 320 also has a backside 324 (e.g., a second side) which is the side opposite the frontside 322 and/or the side of the structure 320 that is not readily or easily accessible. For example, the backside 324 of a structure 320 may be the interior of a structure 320, such as the interior of the wing box 308 of FIGS. 3-4.

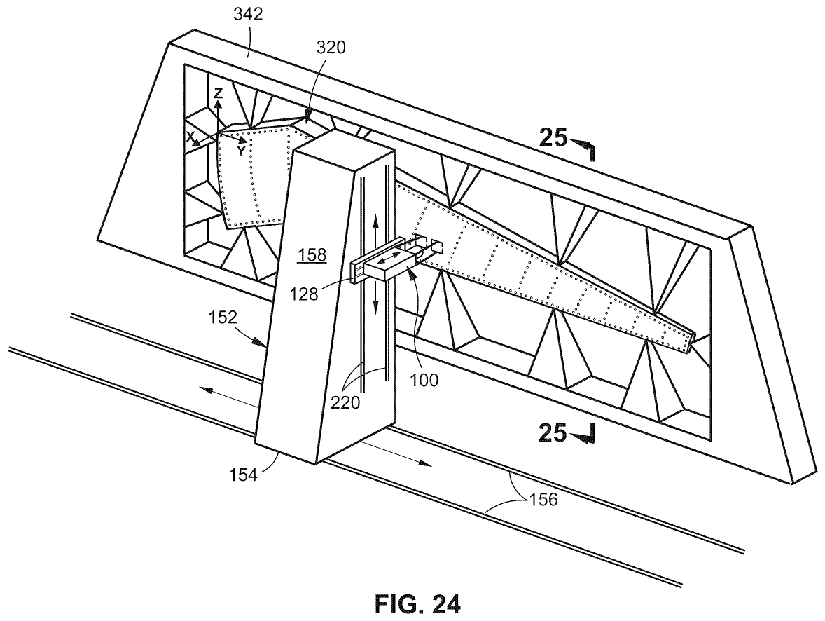

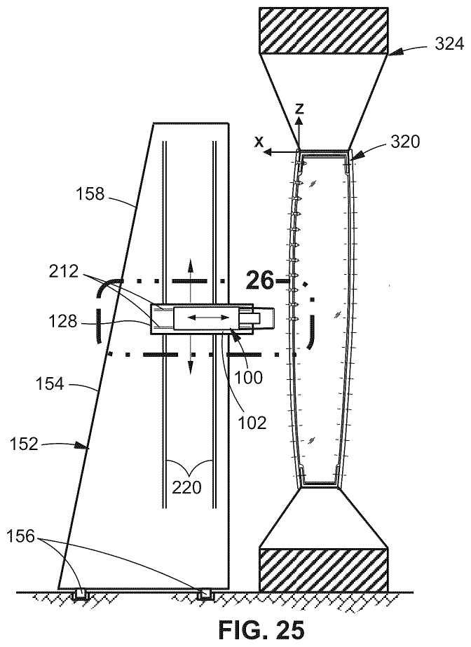

In the example of FIGS. 3-4, the movable platform 140 is a robotic device 142. The robotic device 142 has a robotic arm 148 to which the x-ray device 102 is mounted. The robotic device 142 is movable along robotic device tracks 150, enabling the x-ray device 102 to be positioned at any location along the wing box 308. Although FIGS. 3-4 show the movable platform 140 as a robotic device 142, in other examples, the movable platform 140 can be provided as a machine 152 such as a computer-numerical-controlled (CNC) machine 154 as shown in FIGS. 24-25 and described below.

Although FIGS. 2-4 show the use of the backscatter x-ray system 100 in the context of a wing box 308 of an aircraft 300, the backscatter x-ray system 100 can be implemented for performing manufacturing and/or inspection operations on any one of a variety of different types of structures 320 of any size, shape, and configuration. In addition, the backscatter x-ray system 100 can be implemented on any type of assembly, subassembly, system, subsystem, platform, object, building, or vehicle, including air vehicles, land vehicles, sea vessels, and space vehicles. The structure 320 can be a metallic structure, a composite structure 338 (e.g., a laminate of graphite-epoxy composite plies) or a structure 320 comprised of a combination of metallic and composite materials. The structure 320 can be a single structural component 330 or the structure 320 can be a structural assembly 328 comprised of two or more structural components 330. For example, the structural assembly 328 can include a first structural component 332 such as a skin panel 310, and a second structural component 334 such as the above-mentioned substructure 326 of the wing box 308.

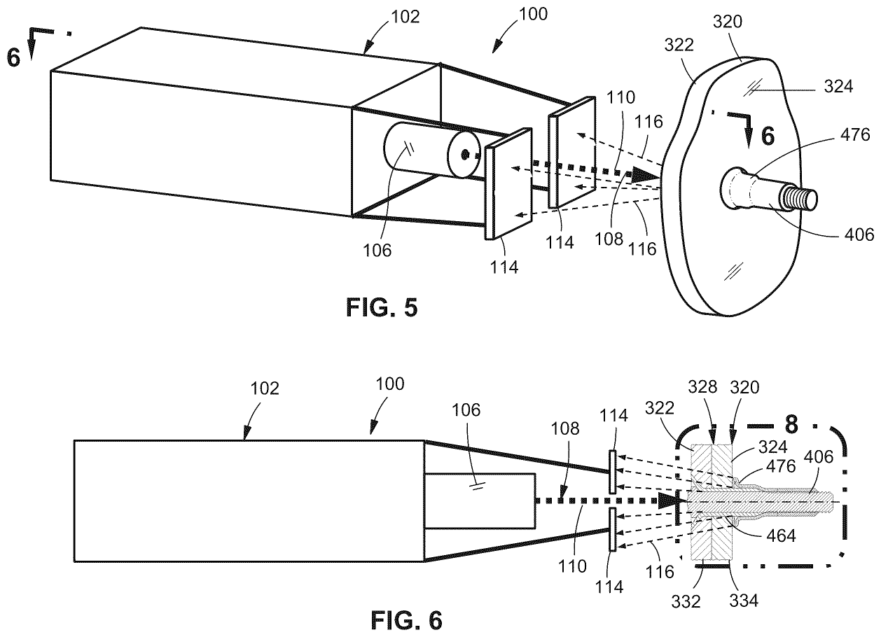

Referring to FIGS. 5-6, shown is an example of an x-ray device 102 as used in the presently-disclosed backscatter x-ray system 100. As mentioned above, the x-ray device 102 includes an x-ray emitter 106 (e.g., an x-ray tube) configured to emit x-rays 108. In the present disclosure, the x-rays 108 are represented as an x-ray beam 110. The x-rays 108 can be emitted in any one a variety of shapes. For example, the x-rays 108 can be emitted generally parallel to each other, or the x-rays 108 can be emitted in a cone shape to increase the area of coverage of a structure 320. The x-rays 108 penetrate or pass through the structure 320 in a first general direction moving away from the x-ray device 102. When the emitted x-rays 108 encounter internal features 474 and/or backside features 476 of a structure 320 and/or fastener installations 406, at least some of the x-rays 108 reflect (i.e., scatter) off one or more surfaces and are directed back toward the x-ray device 102.

In addition to an x-ray emitter 106, the x-ray device 102 includes one or more x-ray detectors 114 (e.g., imaging plates) located on the same side of the structure 320 (i.e., the frontside 322) as the x-ray emitter 106. The one or more x-ray detectors 114 are configured to detect photons in at least a portion of the backscatter 116 of x-rays 108 reflected from the structure 320. The reflected and or deflected x-rays 108 scatter back to the x-ray detectors 114 in a second general direction opposite the first general direction. The x-ray detectors 114 are configured to capture a backscatter 116 of x-rays 108 reflected off any one of a variety of different types of features of the structure 320 including the above-mentioned internal features 474 and/or backside features 476 and/or fastener installations 406.

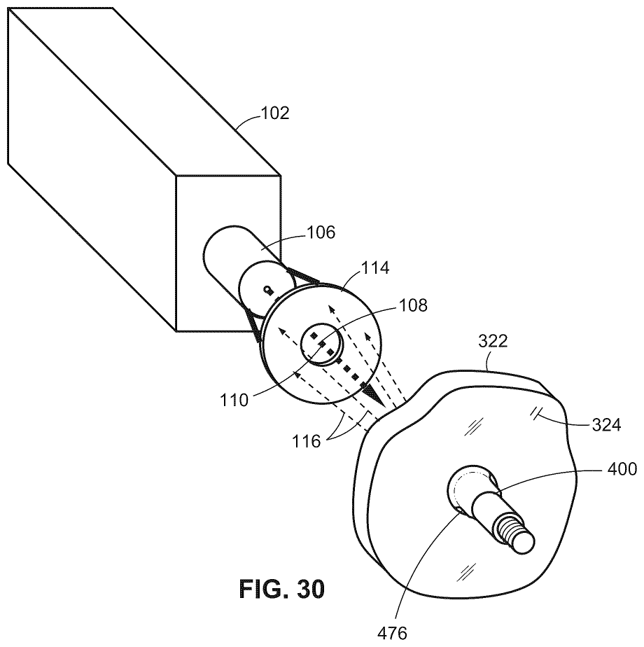

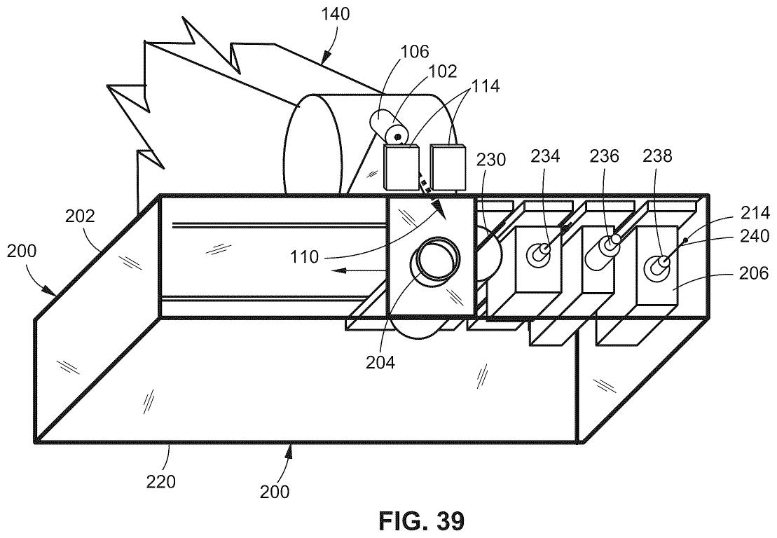

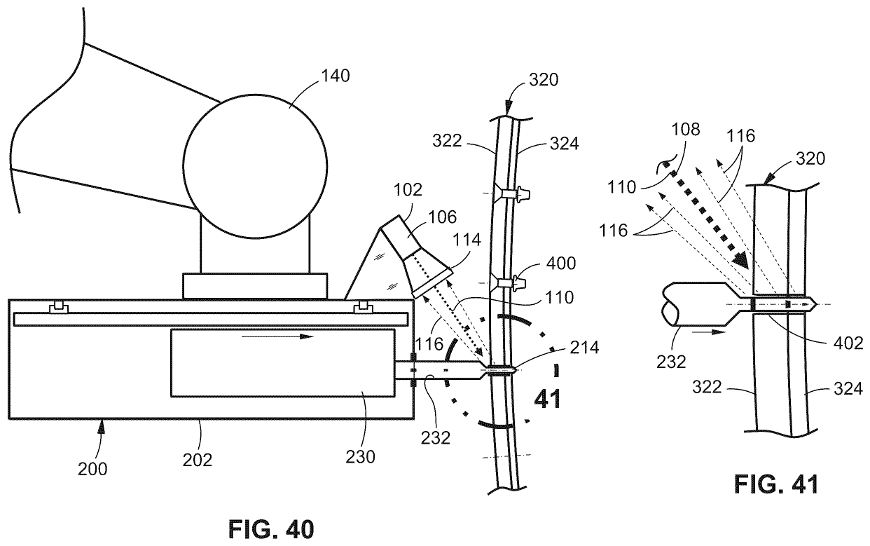

In the example of FIGS. 5-6, the x-ray device 102 includes a side-by-side pair of x-ray detectors 114 which are spaced apart to define a gap through which the emitted x-rays 108 pass. In the example shown, the x-ray detectors 114 are mounted to and supported by the x-ray emitter 106. However, in other examples not shown, the x-ray detectors 114 can be supported via other means such as via mounting to a multi-function end effector 200 (e.g., MFEE—FIGS. 39-40) to which the x-ray emitter 106 can also be mounted. Although the x-ray device 102 of FIGS. 5-6 has two x-ray detectors 114, an x-ray device 102 may have a single x-ray detector 114 (e.g., FIG. 30) or an x-ray device 102 may have more than two x-ray detectors 114. Furthermore, although FIGS. 5-6 show the x-ray detectors 114 having an orthogonal shape, the x-ray detectors 114 can be provided in any shape and size that is complementary to the operating parameters of the x-ray device 102 and/or complementary to the configuration of the structure 320 being inspected. Although not shown, the backscatter x-ray system 100 can optionally include a radiation shield (e.g., a lead shield) surrounding the x-ray device 102 to at least partially contain x-rays 108 emitted by the x-ray device 102 and/or backscattered (e.g., reflected) from the structure 320.

The x-ray device 102, at least when emitting x-rays 108, is preferably positioned in non-contacting relation to the frontside 322 of the structure 320. In addition, the x-ray device 102 is located at a distance from the frontside 322 that allows the x-ray detectors 114 to capture the backscatter 116 of x-rays 108. More specifically, the x-ray device 102 is positioned at distance from the frontside 322 allowing the emitted x-rays 108 to interact with the structure 320, and allowing the backscatter 116 of x-rays 108 to be detected by the x-ray detectors 114.

Referring to FIG. 3, the backscatter x-ray system 100 further includes a processor 122 communicatively coupled to the x-ray device 102. In the example shown, the processor 122 is incorporated into a computer 120 (i.e., a laptop) located adjacent to the x-ray device 102 near the assembly fixture 342. However, in other examples, the processor 122 (e.g., computer 120) can be located remotely from the x-ray device 102. The processor 122 is wirelessly or hardwire connected to the x-ray device 102. The processor 122 is configured to control the operation of the x-ray device 102 and can also control the operation of the movable platform 140.

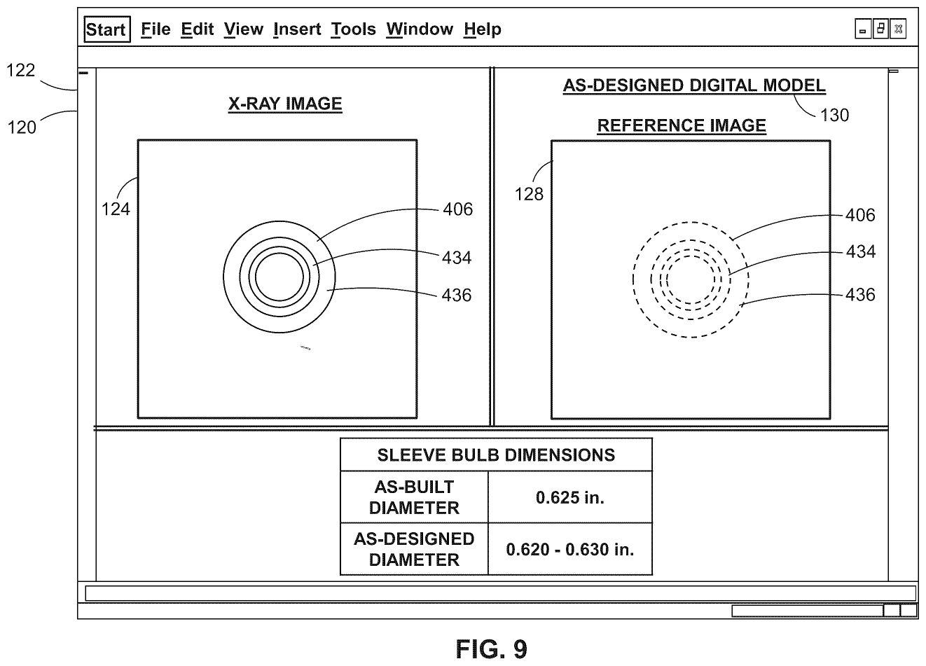

As described in greater detail below, the processor 122 is configured to process data from the x-ray detectors 114 regarding backscattered x-rays 108 detected by the x-ray detectors 114. In this regard, the processor 122 generates x-ray images 124 (FIG. 9) of the structure 320 based on the backscatter 116 detected by the x-ray detectors 114. In addition, the processor 122 uses vision technology to analyze the x-ray images 124 in a manner facilitating the manufacturing and/or inspection of the structure 320. For example, the processor 122 analyzes the x-ray images 124 to detect inconsistencies and/or non-conformances 480 and print FIG. 19) in one or more aspects in, of, on, and/or near a structure 320 and/or a fastener installation 406 in the structure 320. For example, the processor 122 is configured to process data from x-rays 108 backscattered from a fastener installation 406 in the structure 320 (e.g., FIGS. 5-6), and generate x-ray images 124 that are used to determine whether the fastener installation 406 is in conformance with fastener installation requirements.

As described in greater detail below, the processor 122 analyzes the x-ray images 124 and distinguishes the different components of a fastener installation 406 to validate that a fastener 400 is installed correctly. In a specific example, the processor 122 can compare x-ray images 124 to a dataset of nominal dimensions associated with the structure 320 to determine if the fastener installation 406 is in conformance with fastener installation requirements. In another example, the processor 122 can analyze the gray pattern (not shown) or gray density (not shown) of the x-ray images 124 and determine if a fastener 400 is installed correctly. In yet another example, the processor 122 can compare x-ray images 124 to a reference image 128 (FIG. 9) of a nominal version of the fastener installation 406 to determine conformance with the fastener installation requirements. The dataset of nominal dimensions and the reference image 128 are stored in a memory 126 (FIG. 3) that is communicatively coupled to the processor 122.

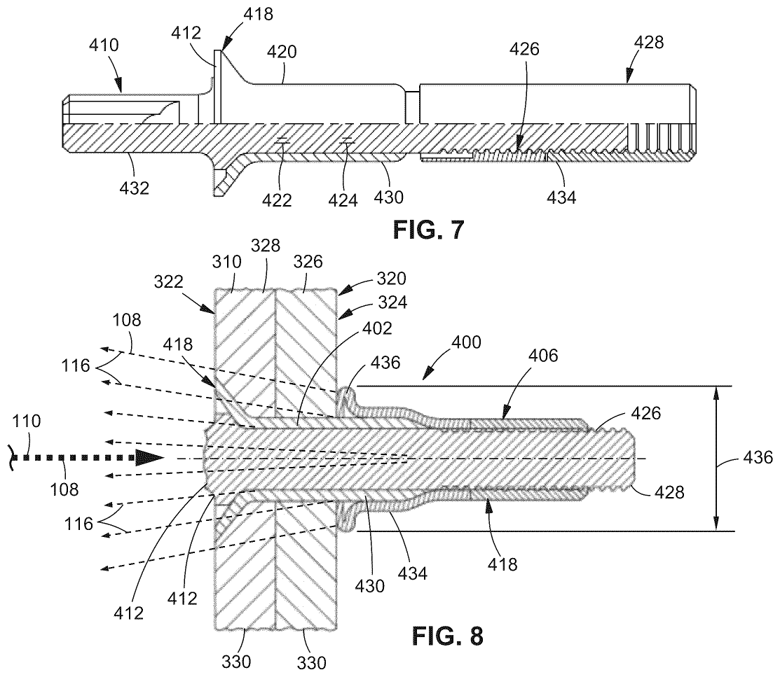

FIGS. 7-8 show an example of a one-sided fastener 418 in the form of a sleeved fastener 420 as may be used to fasten skin panels 310 to a substructure 326, such as fastening the skin panels 310 to the front spar 314, rear spar 316, and wing ribs 312 that make up the substructure 326 of the wing box 308 (e.g., of FIGS. 2-4). In FIG. 7, the one-sided fastener 418 has a head end 410 (e.g., a first end) and a tail end 428 (e.g., a second end). The one-sided fastener 418 includes a fastener body 422 that extends between the head end 410 and the tail end 428. The head end 410 of the fastener body 422 has a fastener head 412. As shown in FIG. 7, a frangible drive nut 432 protrudes from the fastener head 412. The fastener body 422 has a shaft portion 424 that extends from the fastener head 412 on the head end 410 of the one-sided fastener 418 to a threaded portion 426 on the tail end 428 of the one-sided fastener 418. The shaft portion 424 is surrounded by an internal sleeve 430. A nut sleeve 434 is threadably engaged to the threaded portion 426.

During installation, the one-sided fastener 418 is inserted into a fastener hole 402 (FIG. 8) from the frontside 322 of the structure 320, such as the structural assembly 328 of FIG. 8. A fastener installation tool (not shown) rotates the drive nut 432 in a manner causing the fastener body 422 to rotate relative to the nut sleeve 434 located on the backside 324 of the structure 320. Due to the threaded engagement of the nut sleeve 434 to the threaded portion 426, rotation of the fastener body 422 causes the nut sleeve 434 to axially move into engagement with the internal sleeve 430. Continued rotation of the fastener body 422 causes a lengthwise section of the nut sleeve 434 to axially slide over the internal sleeve 430. As the end of the nut sleeve 434 axially moves into contact with the backside 324 surface of the structure 320, continued rotation of the fastener body 422 (e.g., via the fastener installation tool) causes the end of the nut sleeve 434 to fold over onto itself and radially expand against the backside 324 of the structure 320, ultimately forming a sleeve bulb 436 which clamps together the structural components 330 of the structural assembly 328. The frangible drive nut 432 (FIG. 7) fractures off the fastener head 412 when a predetermined torque level is reached, which corresponds to a predetermined clamp-up force exerted by the sleeve bulb 436 on the structure 320.

FIG. 8 also shows the x-ray beam 110 of x-rays 108 emitted by the x-ray device 102 of FIGS. 5-6, which is positioned in alignment with the one-sided fastener 418 after installation. The emitted x-rays 108 penetrate the structure 320 and the one-sided fastener 418, and a portion of the x-rays 108 are reflected off of the sleeve bulb 436 and other components of the one-sided fastener 418 located on the backside 324 of the structure 320. The backscatter 116 of x-rays 108 is detected by the x-ray detectors 114 on the frontside 322 of the structure 320.

Referring to FIG. 9, shown is an example of a display screen of the computer 120 of FIG. 3 displaying an x-ray image 124 of the portion of the fastener installation 406 on the backside 324 of the structure 320 of FIG. 8. The x-ray image 124 is generated by the processor 122 based on the backscatter 116 detected by the x-ray detectors 114 of the x-ray device 102. Also displayed on the display screen of FIG. 9 is a reference image 128 of a nominal version of the installation of the one-sided fastener 418. In one example, the nominal version of the fastener installation 406 can be generated from an as-designed digital model 130 of the structure 320.

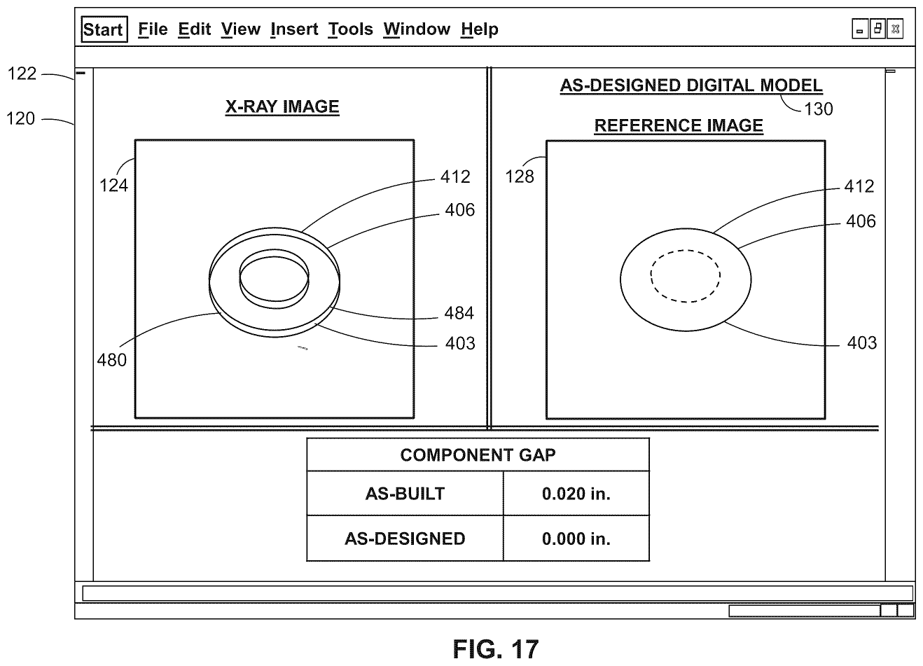

The processor 122 is configured to compare the x-ray image 124 to the reference image 128, and detect potential inconsistencies and/or non-conformances 480 (FIG. 17) in the sleeve bulb 436 of the fastener installation 406. In FIG. 9, the x-ray image 124 and the reference image 128 each show the sleeve bulb 436 of the nut sleeve 434 of the one-sided fastener 418. The processor 122 can analyze and/or measure the bulb diameter 438 (FIG. 8) of the sleeve bulb 436, and determine if the sleeve bulb 436 is properly formed. For example, the processor 122 can measure and/or list the bulb dimensions (e.g., bulb diameter 438) of the x-ray image 124 (i.e., the as-built diameter) and of the reference image 128 (i.e., the as-designed diameter), and display the results on the display screen as shown in FIG. 9. In the example shown, the bulb diameter 438 of the sleeve bulb 436 in the reference image 128 falls within the range of acceptable bulb diameters of a sleeve bulb 436 of the as-designed digital model 130.

The backscatter x-ray system 100 is not limited to inspecting the bulb diameters 438 of sleeve bulbs 436 of one-sided fasteners 418, but can be used for inspecting any one of a variety of other aspects of fastener installations 406. For example, the backscatter x-ray system 100 can generate and analyze x-ray images 124 to determine whether the dimensions and/or shape of any type of fastener installation 406 are within established tolerances. In the example of FIG. 8, the backscatter x-ray system 100 can determine whether the amount by which the fastener body 422 protrudes beyond the nut sleeve 434 is within an acceptable range, or if the grip length of the one-sided fastener 418 is within an acceptable range. The backscatter x-ray system 100 can also generate and analyze x-ray images 124 to determine: if there is a gap between the sleeve and the backside 324 of the structure 320, if the sleeve is formed at all, if the sleeve is missing, or any one of a variety of other aspects of fastener installations 406.

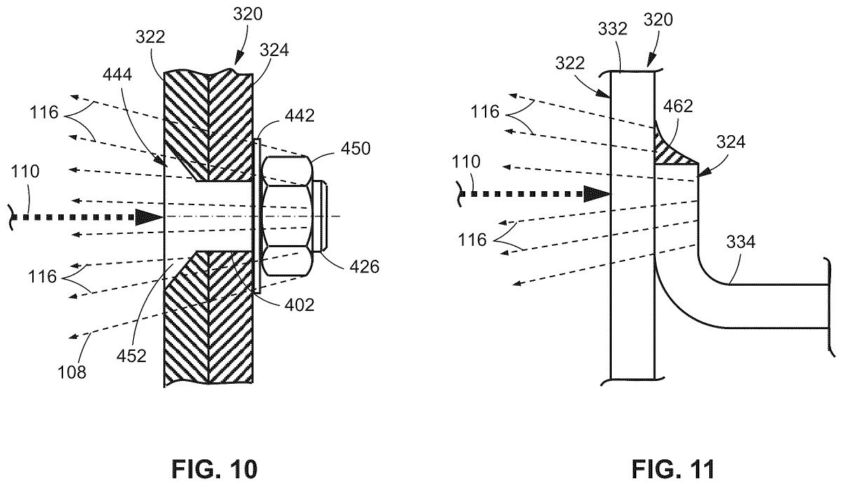

The backscatter x-ray system 100 is not limited to inspecting one-sided fasteners 418 as shown in FIGS. 7-8, but can inspect any one of a variety of other types of fasteners 400 such as two-part fasteners 444 (FIG. 13) such as a pin 446 and collar 448 combination (e.g., a Hi-Lok™ fastener) or a conventional nut 450 and bolt 452 combination. For example, FIG. 10 shows an example of the backscatter x-ray system 100 (FIGS. 5-6) inspecting the installation of a nut 450 and bolt 452. A washer 442 is included between the nut 450 and the backside 324 of the structure 320. As described above, the x-ray device 102 emits an x-ray beam 110 which penetrates the structure 320 and the two-part fastener 444. The backscatter 116 of reflected x-rays 108 are detected by the x-ray detectors 114 (FIGS. 5-6), and the processor 122 (FIG. 3) generates x-ray images 124 (not shown) of the installation of the two-part fastener 444. Similar to the above-described example shown in FIG. 9, the processor 122 is configured to analyze the x-ray images 124 of the two-part fastener 444 in a manner detecting non-conformances 480 or inconsistencies in the fastener installation 406, such as by comparing x-ray images 124 of the fastener installation 406 to reference images 128, or by comparing x-ray images 124 to a dataset of nominal dimensions for the two-part fastener 444, or by analyzing the gray pattern or gray density of the x-ray images 124.

Referring to FIG. 11, shown is an example of the backscatter x-ray system 100 (FIGS. 5-6) inspecting a sealant 462 installed on the backside 324 of a structure 320. The structure 320 is comprised of a first structural component 332 and a second structural component 334. In the example shown, the sealant 462 has been applied as a bead extending along the edge of the second structural component 334 on the backside 324 of the structure 320. To inspect the sealant 462, the backscatter x-ray system 100 is operated in the manner described above in which the x-ray device 102 emits an x-ray beam 110 which penetrates the first structural component 332 and reflects off the sealant 462 bead and the second structural component 334. The backscatter 116 of reflected x-rays 108 are detected by the x-ray detectors 114, and the processor 122 uses the backscatter 116 data to generate x-ray images 124 (not shown) showing the sealant 462 and the structure 320. The processor 122 can analyze the x-ray images 124 to determine if there are any gaps between the sealant 462 and the surface of the first structural component 332 along the length of the bead, or any gaps between the sealant 462 and the edge of the second structural component 334. The processor 122 can also analyze the x-ray images 124 to measure the width of the sealant 462 bead at different locations along its length, and determine if the width is in conformance with design requirements. The processor 122 can also analyze the x-ray images 124 to determine if there are any voids (not shown) within the sealant 462 bead, and if any sections of the sealant 462 bead are missing along its length.

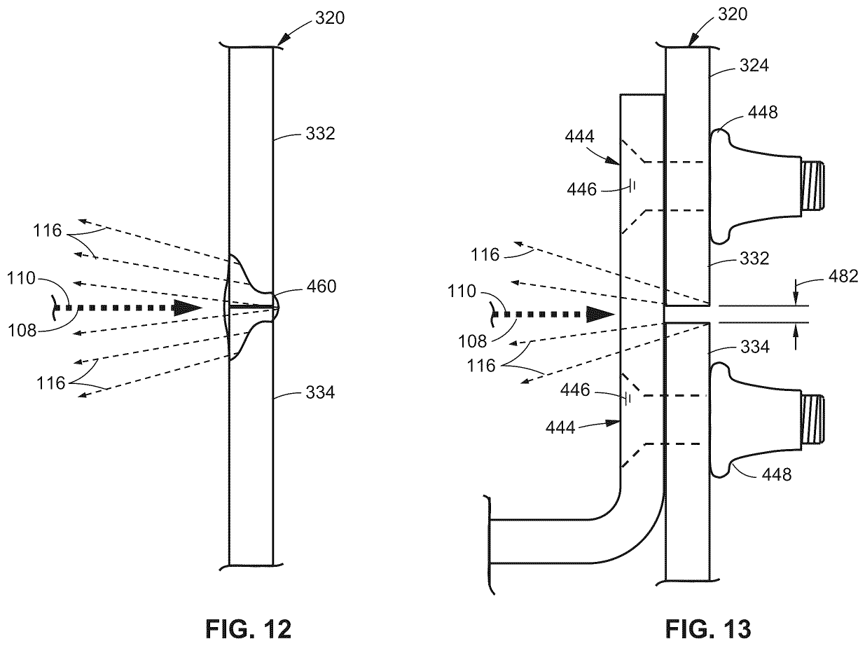

Referring to FIG. 12, shown is an example of the use of the backscatter x-ray system 100 to inspect a welding bead 460 after its completion. In the example shown, the welding bead 460 joins a first structural component 332 to a second structural component 334. Similar to the process described above, the movable platform 140 (FIGS. 3-4) can move the x-ray device 102 to different locations along the welding bead 460, stopping at each location to perform an inspection of the welding bead 460. Alternatively, the movable platform 140 can move the x-ray device 102 along the welding bead 460 while the x-ray emitter 106 continuously emits an x-ray beam 110 of x-rays 108 which penetrates the first and second structural components 332, 334 and the welding bead 460. The backscatter 116 of reflected x-rays 108 are continuously detected by the x-ray detectors 114 (FIGS. 5-6). The processor 122 uses the backscatter 116 data to periodically or continuously generate x-ray images 124 (not shown) which are analyzed by the processor 122 to assess the integrity of the welding bead 460. For example, the processor 122 can use any of the above-described techniques to analyze the x-ray images 124 to detect the presence of porosity (not shown) or cracks (not shown) in the welding bead 460, or to determine if the welding bead 460 is completely fused to each of the first and second structural components 332, 334 and/or if the welding bead 460 penetrates through the full thickness of the first and second structural components 332, 334.

Referring to FIG. 13, shown is an example of the use of the backscatter x-ray system 100 to inspect a structural assembly gap 482 between a first structural component 332 and a second structural component 334 located on the backside 324 of the structure 320. The movable platform 140 can move the x-ray device 102 along the structural assembly gap 482 while the x-ray emitter 106 emits x-rays 108 that penetrate the structure 320. The backscatter 116 of reflected x-rays 108 are detected by the x-ray detectors 114. The processor 122 uses the backscatter 116 of reflected x-rays 108 to generate x-ray images 124 that are analyzed (continuously or periodically) to determine if the width of the structural assembly gap 482 at one or more locations is in conformance with design requirements.

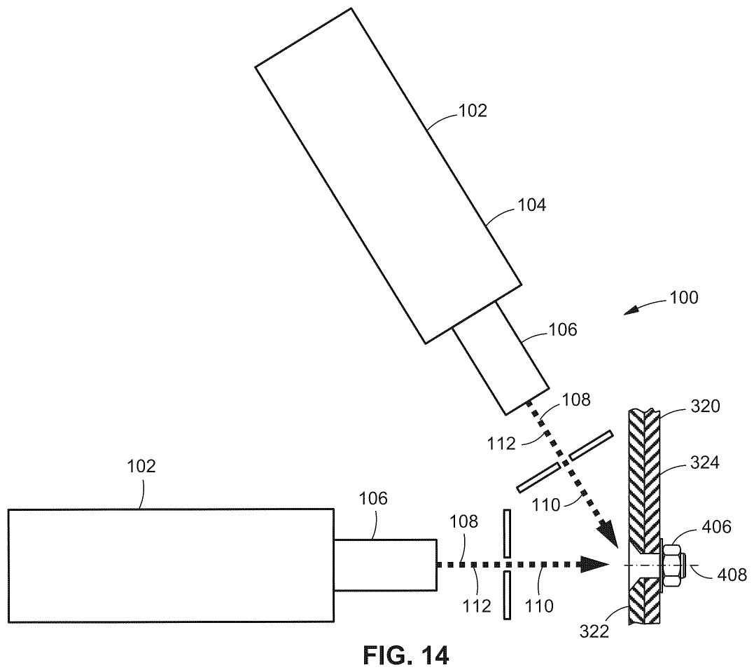

Referring to FIG. 14, shown is an example of a backscatter x-ray system 100 having two x-ray devices 102 having different orientations relative to a fastener installation 406 in a structure 320. The two x-ray devices 102 are mounted on the same movable platform 140 (not shown) such as the robotic arm 148 of FIGS. 3-4. The x-rays 108 emitted by each x-ray emitter 106 define an x-ray beam 110. Each x-ray beam 110 defines a beam central axis 112 representing the general direction of the x-ray beam 110. The movable platform 140 (FIGS. 3-4) is capable of orienting the x-ray devices 102 such that the beam central axis 112 of x-rays 108 emitted by at least one of the x-ray devices 102 is parallel to the fastener centerline 408 of the fastener installation 406, or locally perpendicular to a frontside 322 surface of the structure 320. Alternatively or additionally, the movable platform 140 can orient at least one of the x-ray devices 102 (i.e., off-axis x-ray devices 104) such that its beam central axis 112 is non-parallel to the fastener centerline 408 or locally non-perpendicular to a frontside 322 surface of the structure 320.

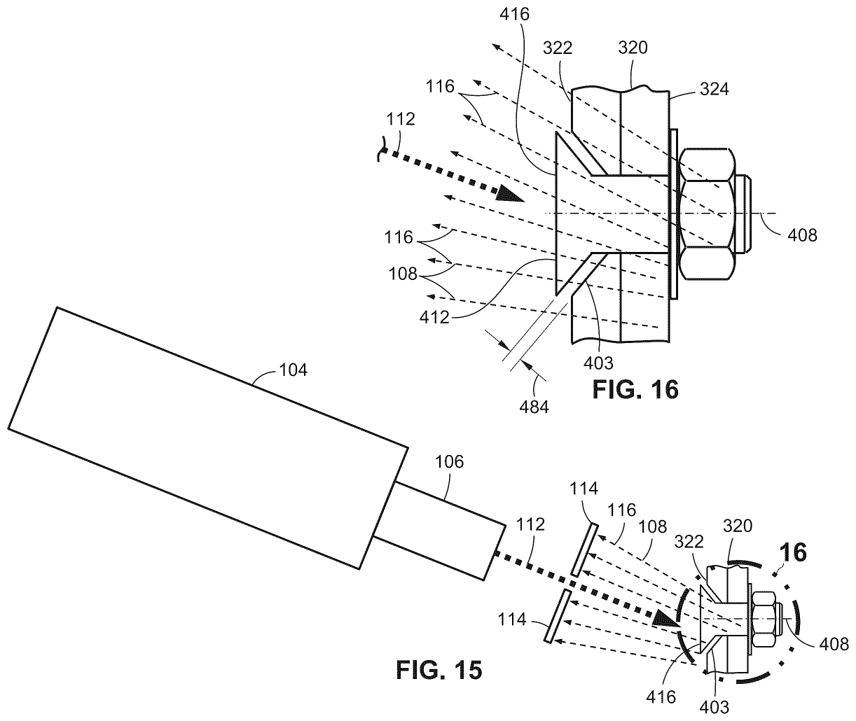

Referring to FIGS. 15-16, shown is an example of an off-axis x-ray device 104 in which the beam central axis 112 is non-parallel to the fastener centerline 408 of a countersunk fastener 416 installed in a frontside 322 of a structure 320. Orienting the off-axis x-ray device 104 in such a manner allows for the inspection of certain aspects of a structure 320 or a fastener installation 406 which are not inspectable when the beam central axis 112 is parallel to the fastener centerline 408. For example, a non-parallel orientation of the beam central axis 112 allows for detection of a head-to-structure gap 484 between a fastener head 412 and a countersink 403 formed in the frontside 322 of the structure 320.

FIG. 17 shows a display screen of a computer 120 displaying an x-ray image 124 of the fastener installation 406 of FIG. 16. Similar to the process described above in relation to FIG. 9, the x-ray image 124 in FIG. 17 is generated by the processor 122 based on backscatter 116 (FIGS. 15-16) data provided by the x-ray detectors 114 (FIG. 15) in response to x-rays 108 reflecting off the different surfaces of the fastener head 412 and the countersink 403 in the frontside 322 of the structure 320. Also displayed on the display screen of FIG. 17 is a reference image 128 of a nominal version of the fastener installation 406 in which the fastener head 412 is properly seated in the countersink 403 (i.e., no head-to-structure gap 484). In one example, the reference image 128 of the nominal version can be generated from an as-designed digital model 130 of the structure 320.

As an alternative to detecting a head-to-structure gap 484 by comparing the x-ray image 124 to a reference image 128, the processor 122 can be programmed to detect the presence of the head-to-structure gap 484 by analysis of an x-ray image 124 to detect the presence of non-overlapping edges of the outer circumference of the fastener head 412 and the outer circumference of the countersink 403 in the frontside 322 of the structure 320, which would otherwise appear as a single edge as shown in the reference image 128 and in which the fastener head 412 is properly seated in the countersink 403. In FIG. 17, the processor 122 can measure the size of the head-to-structure gap 484 (if any) in the x-ray image 124 and the size of the head-to-structure gap 484 (if any) in the reference image 128, and display the results on the display screen.

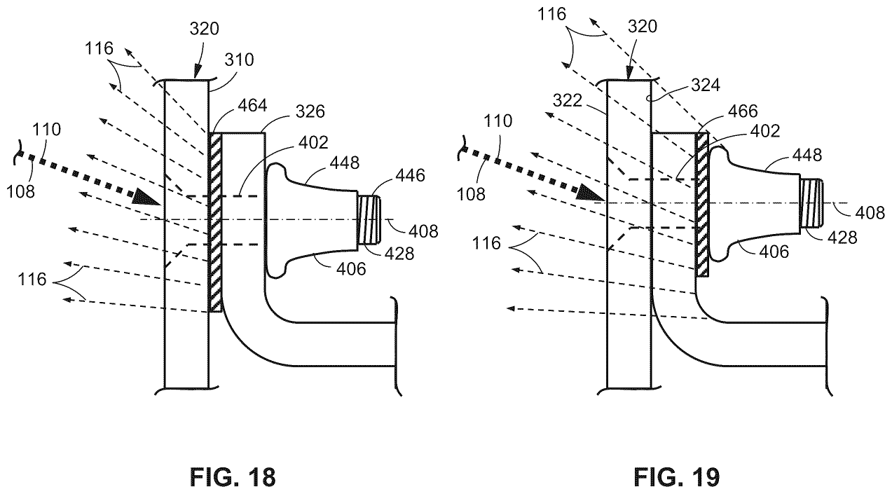

Although not shown, an off-axis x-ray device 104 can be used to inspect a fastener installation 406 for the presence of a receptacle-to-component gap (not shown) between a receptacle 440 and a backside 324 of structure 320. In the present disclosure, a receptacle 440 can be described as a fastener element located or installed on the tail end 428 of a fastener 400 for the purpose of securing two or more structural components 330 together and/or to ensure that the fastener 400 remains securely in place when a load is applied to the fastener 400 and/or the structure 320. Examples of the receptacle 440 include the above-mentioned nut sleeve 434 which is threadably engaged to the threaded portion 426 of a one-sided fastener 418. Other examples of a receptacle 440 include the above-mentioned nut 450 (FIG. 16) which is threadably engaged to the threaded portion 426 of a bolt 452, or a collar 448 (FIG. 18) that is swaged onto the pin 446 of a Hi-Lok™, or any one of a variety of other types of receptacles 440 installed on the tail end 428 of a fastener 400.

Referring to FIGS. 18-23, shown are examples of the use of x-rays 108 from an off-axis x-ray device 104 (not shown) for inspecting a structure 320 for inconsistencies or non-conformances 480 in the material stackup of a structure 320. For example, FIG. 18 shows an x-ray beam 110 oriented non-parallel to the fastener centerline 408 for detecting the presence or absence of a shim 464 in the material stackup of the structure 320. The shim 464 is located between a skin panel 310 and a substructure 326, and the processor 122 (FIG. 3) is configured to detect or validate the presence of the shim 464 by comparing the x-ray image 124 (FIG. 9) to a reference image 128 (FIG. 9) of an as-designed digital model 130 of the fastener installation 406. Alternatively or additionally, the processor 122 can analyze the gray pattern (not shown) or gray density (not shown) of the x-ray images 124 to detect or validate the presence of the shim 464.

FIG. 19 shows an example of the use of x-rays 108 from an off-axis x-ray device 104 inspecting a structure 320 for the presence or absence of a doubler 466 on the backside 324 of the structure 320. In x-ray images 124 (not shown) generated by the backscatter x-ray system 100, the shim 464 can be detected due to the appearance of lines on the x-ray image 124 that represent the edges of the shim 464. Although not shown, the off-axis x-ray device 104 can also be used to inspect for gaps (not shown) in the material stackup of a structure 320, such as a gap between a skin panel 310 and the substructure 326 underneath the skin panel 310. The off-axis x-ray device 104 can also be used to inspect for missing layers (not shown) in a material stackup.

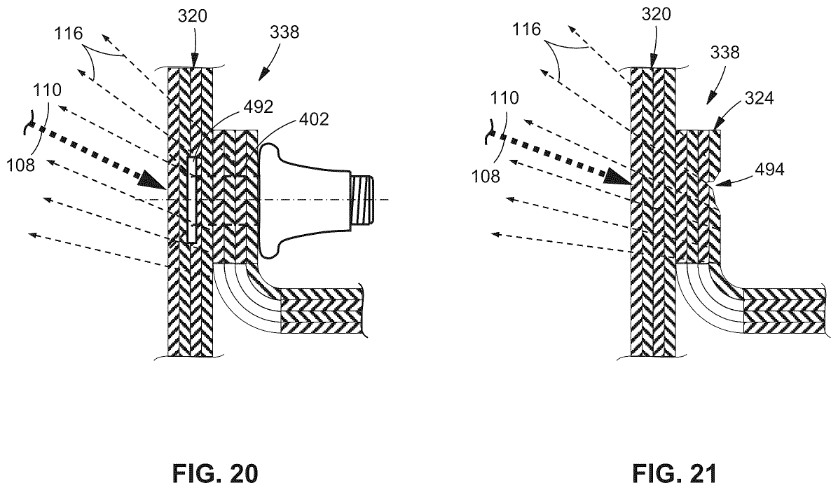

FIG. 20 shows an example of the use of x-rays 108 from an off-axis x-ray device 104 inspecting a composite structure 338 for the presence of interlaminar counterbores 492. Such interlaminar counterbores 492 can be caused by burrs (not shown) generated by a drill bit (not shown) when forming a fastener hole 402 in the composite structure 338. In an x-ray image 124 (not shown) of the fastener installation 406 of FIG. 20, an interlaminar counterbore 492 may be detectable due to its darker appearance relative to the surrounding structure 320 in the x-ray image 124.

FIG. 21 shows an example of the use of x-rays 108 from an off-axis x-ray device 104 inspecting a structure 320 for the presence of gashes 494, dents, or other damage or anomalies on the backside 324 of the structure 320. In an x-ray image 124 (not shown) of the fastener installation 406 of FIG. 21, a gash 494 on the backside 324 of the structure 320 may be detectable as a discontinuity in the gray pattern (not shown) or gray density (not shown) of the x-ray image 124 at the location of the gash 494.

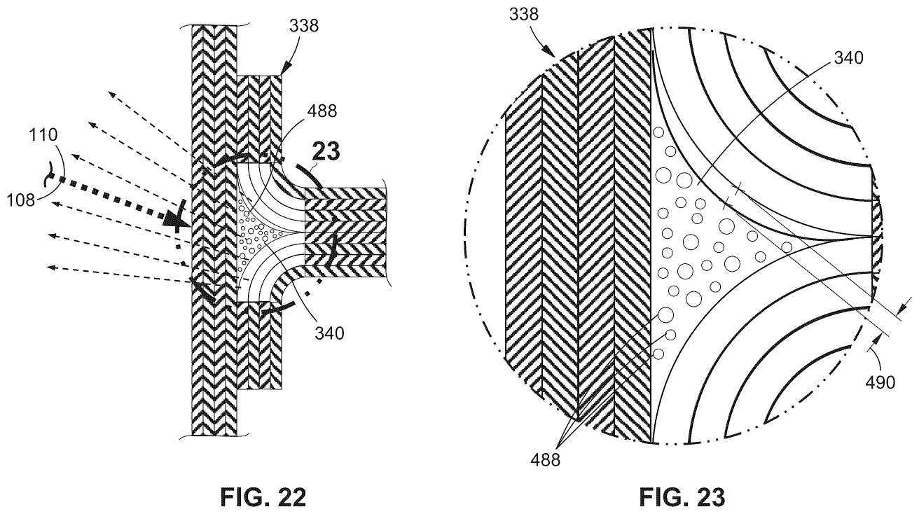

FIG. 22-23 show an example of the use of x-rays 108 from an off-axis x-ray device 104 for inspecting a composite structure 338 for porosity 488 and/or voids 490. In the example shown, the composite structure 338 has a radius filler 340. As shown in FIG. 23, the radius filler 340 has porosity 488, which will appear as dark spots in an x-ray image 124 (not shown) of the radius filler 340 and surrounding composite structure 338. Also shown in FIG. 23 is a separation or void 490 between one side of the radius filler 340 and the composite structure 338. Similar to porosity 488, a void 490 in an x-ray image 124 (not shown) will appear darker than the surrounding composite structure 338. In this same manner, the backscatter x-ray system 100 can be used to generate x-rays 108 for inspecting a metallic structure for the presence of defects such as degradation, cracks (e.g., fatigue cracks), corrosion, and other metal defects.

In addition to the above-described aspects shown in the figures, the presently disclosed backscatter x-ray system 100 can also inspect a structure 320 for a variety of other aspects using the above-described process of emitting x-rays 108 toward a frontside 322 of a structure 320, detecting the backscatter 116 of x-rays 108 reflected off the structure 320, generating x-ray images 124 from the backscatter 116, and then analyzing the x-ray images 124 such as by comparison to reference images 128. For example, the backscatter x-ray system 100 can inspect a fastener installation 406 for a missing collar 448 (FIG. 18)) on a tail end 428 of a pin 446 (e.g., of a Hi-Lok™), a non-conforming or improper swage of the collar 448, a missing or non-conforming receptacle (e.g., a nut 450—FIG. 10) on the threaded portion 426 of a two-part fastener 444 (e.g., a bolt 452), and other aspects. In addition, the backscatter x-ray system 100 can inspect fastener holes 402 in a structure 320, such as the hole diameter, the hole roundness, and the hole location or edge distance 404 (FIG. 53) relative to a backside feature 476 (FIG. 53) such as a part edge 336 (FIG. 53) of a substructure 326 (FIG. 53).

In addition, the backscatter x-ray system 100 can inspect a structure 320 to determine the material density and/or material composition of the structure 320. For example, using the above-described process, the processor 122 of the backscatter x-ray system 100 can analyze x-ray images 124 of a structure 320 and determine the material density and/or material composition of the structure 320 by correlating a gray pattern (not shown) or gray density (not shown) of the x-ray images 124 to a known gray pattern or gray density exhibited by reference images 128 of material having different material compositions. For example, by analyzing x-ray images 124 and comparing them to reference images 128, the processor 122 can determine if the structure 320 is formed of metallic material or non-metallic material (e.g., composite material). For structural assemblies 328 comprised of two or more structural components 330, the processor 122 can determine which structural components 330 are formed of metallic material and which structural components 330 are formed of non-metallic material.

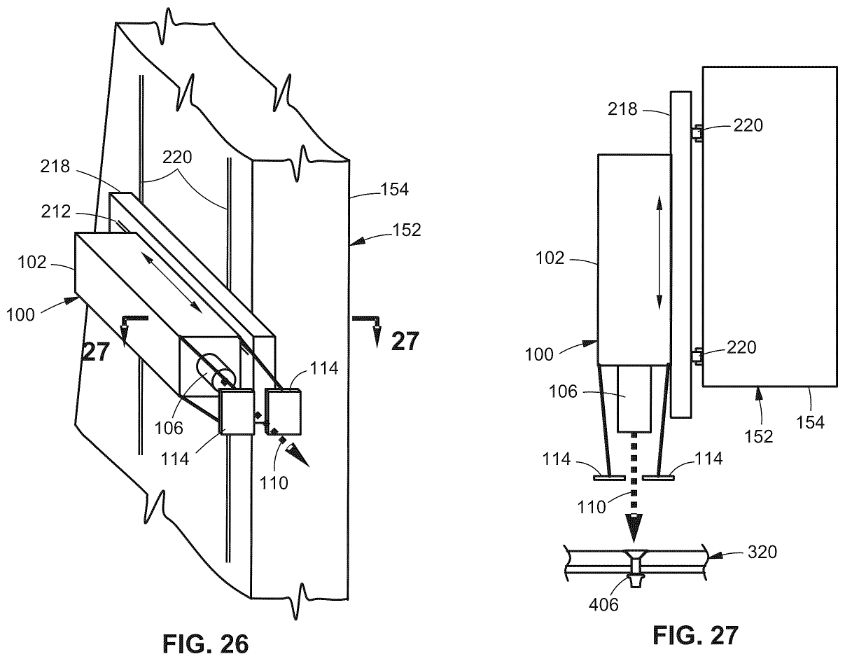

Referring to FIGS. 24-27, shown is an example of a backscatter x-ray system 100 in which the x-ray device 102 is supported by a machine 152, such as a computer-numerical-control (CNC) machine 154. The x-ray device 102 is configured as described above with regard to FIGS. 5-6, but could have any one of a variety of alternative configurations. The machine 152 (e.g., CNC machine 154) can be partially or fully supported by the factory floor, by the factory ceiling, and/or by the assembly fixture 342 that holds the structure 320 that is being assembled or worked on. In FIGS. 24-27, the machine 152 (e.g., CNC machine 154) has a vertically oriented main frame 158 that is movable along machine tracks 156 installed in the factory floor, allowing for horizontal movement of the main frame 158 along the length of the structure 320. The machine 152 includes a tool carrier 218 which is mounted to the main frame 158. The x-ray device 102 is mounted to the tool carrier 218. The main frame 158 includes vertically oriented tool carrier tracks 220 that allow for vertical movement of the tool carrier 218 (and x-ray device 102). The tool carrier 218 includes process tool tracks 212 allowing for movement of the x-ray device 102 in an axial direction. The arrangement of the machine tracks 156, the tool carrier tracks 220, and the process tool tracks 212 allows for positioning of the x-ray device 102 at any three-dimensional location relative to the structure 320.

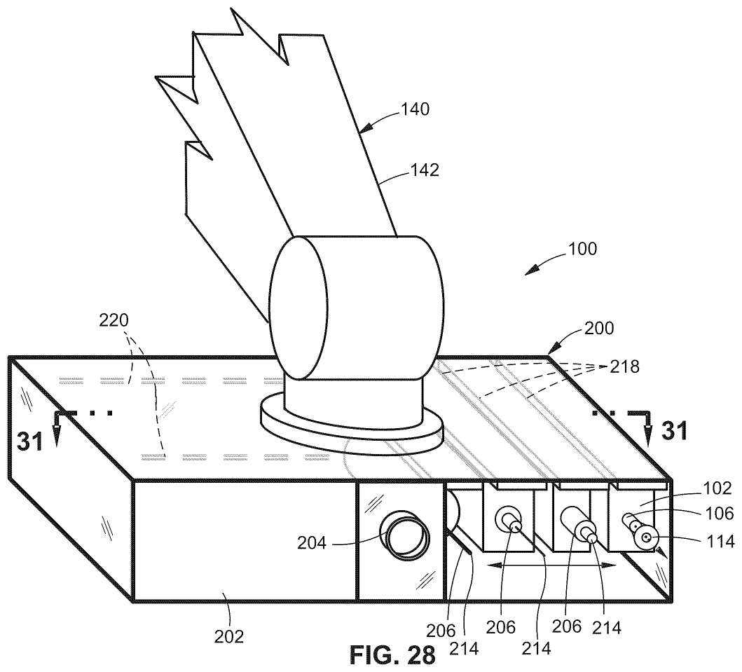

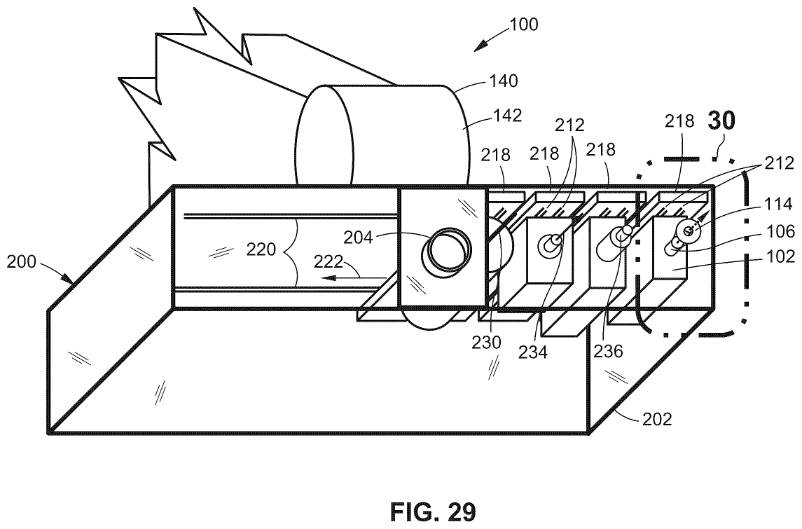

Referring to FIGS. 28-38, shown is an example of a backscatter x-ray system 100 in which the x-ray device 102 is integrated into a multi-function end effector 200 (MFEE). The backscatter x-ray system 100 includes an x-ray emitter 106 and an x-ray detector 114 as shown in FIG. 30 and described below. Although not shown in FIGS. 28-29, a processor 122 is also included with the backscatter x-ray system 100, and which has the same configurations and functionalities as the processor 122 (i.e., computer 120) of the above-described backscatter x-ray system 100 of FIG. 3.

In FIGS. 28-29, 31, 33, 35, and 37, the MFEE 200 has an end effector frame 202 configured to be mounted to a movable platform 140. In the example of FIGS. 28-29, the movable platform 140 is a robotic device 142 having the same configuration and functionalities as the above-described robotic device 142 of FIGS. 3-4. In this regard, the robotic device 142 can position the MFEE 200 at any location along a structure 320. However, the MFEE 200 can be mounted to any one of a variety of alternative types of movable platforms 140 described above, such as the above-described machine 152 or CNC machine 15 (FIGS. 24-25 4.

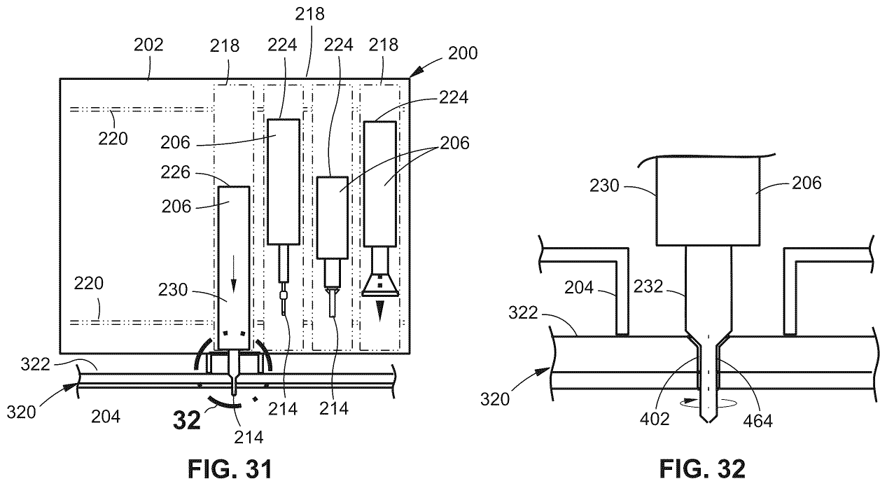

In the examples of FIGS. 28-29, 31, 33, 35, and 37, the end effector frame 202 has a nose piece 204 configured to be placed in contact with a frontside 322 (FIGS. 31-32 of the structure 320, such as during hole formation and/or during installation of a fastener 400. In the example shown, the nose piece 204 is annularly shaped and is placed on the frontside 322 of the structure 320 in a manner such that the nose piece 204 (FIGS. 31-32) surrounds a desired fastener hole 402 (FIGS. 31-32) or a fastener 400 location. In some examples, the nose piece 204 can apply slight clamping pressure against the structure 320 when the MFEE 200 is performing operations on the structure 320. For example, in the wing box 308 of FIGS. 24-25, the nose piece 204 can apply slight clamping pressure of the skin panel 310 against the substructure 326 of the wing box 308 (the front spar 314, rear spar 316, and wing ribs 312) to prevent movement of the MFEE 200 relative to the wing box 308 when the MFEE 200 is performing operations on the wing box 308.

As shown in FIGS. 28-29, the MFEE 200 includes a plurality of process tools 206 mounted or supported by the end effector frame 202. In the example shown, the process tools 206 have different functional capabilities associated with hole formation and fastener 400 installation. The process tools 206 are independently operated and are configured to successively perform their respective functions on the structure 320 as described below.

In the example shown, each process tool 206 has a tool carrier 218 coupled to the end effector frame 202. In addition, each process tool 206 has a working end 214 and a tool axis 216. At least some of the process tools 206 are movable along process tool tracks 212 (FIG. 29) along their respective tool axes 216 between a retracted position 224 (FIG. 31) in which the working end 214 of the process tool 206 is spaced apart from the structure 320, and an extended position 226 (FIG. 31) in which the working end 214 of the process tool 206 is in close proximity to or is engaged with the structure 320 and/or a fastener 400 during or after installation.

The process tools 206 are arranged in a manner such that the tool axes 216 of at least some of the process tools 206 are parallel to each other. Each tool carrier 218 (and its process tool 206) is coupled to the end effector frame 202 via tool carrier tracks 220 oriented perpendicular to the tool axes 216. The tool carrier tracks 220 enable one-at-on-time positioning of each process tool 206 into alignment with the nose piece 204 in preparation for each process tool 206 performing an operation on the structure 320.

In the example of FIGS. 28-38, the process tools 206 in the MFEE 200 include a spindle 230, a hole probe 234, a fastener installer 236, and an x-ray device 102 as part of the backscatter x-ray system 100 disclosed herein. In the example shown, the x-ray device 102 is configured to inspect one or more aspects associated with the formation of fastener holes 402 and the installation of fasteners 400 in a structure 320.

The x-ray device 102 includes an x-ray emitter 106 configured to emit x-rays 108 which are represented as an x-ray beam 110 as described above. The x-ray emitter 106 in FIG. 30 has the same functionalities as the x-ray emitter 106 in FIGS. 5-6. For example, the x-ray emitter 106 emits x-rays 108 toward the frontside 322 of the structure 320 and which penetrate the structure 320. When the emitted x-rays 108 encounter internal features 474 (FIG. 32), and/or backside features 476 (FIG. 36) of the structure 320 (including fasteners 400 installations), at least a portion of the x-rays 108 reflect off the surfaces of the structure 320 and/or fastener installations 406 and are directed back toward the x-ray device 102.

In FIG. 30, the x-ray device 102 includes a single x-ray detector 114 having a disc shape with a central opening through which x-rays 108 emitted by the x-ray emitter 106 can pass. The disc-shaped x-ray detector 114 in FIG. 30 is sized and shaped complementary to the size and shape of the nose piece 204 of the MFEE 200. In the example shown, the outer diameter of the x-ray detector 114 is slightly smaller than the inner diameter of the nose piece 204 to enable the x-ray detector 114 to be positioned in proximity to the structure 320 when the x-ray device 102 is aligned with the nose piece 204. However, the x-ray detector 114 can be provided in any size and shape, and is not limited to a disc shape having a hole in the center. Furthermore, the x-ray device 102 can have more than one x-ray detector 114, and is not limited to the single x-ray detector 114 shown in FIG. 30.

In the example shown, the x-ray detector 114 is mounted to the x-ray emitter 106. However, the x-ray detector 114 can be mounted to the tool carrier 218 (not shown) of the MFEE 200, or the x-ray detector 114 can be supported by other means. The x-ray detector 114 has the same functionalities described above for the x-ray detectors 114 of FIG. 5-6. For example, the x-ray detector 114 of FIG. 30 detects photons in the backscatter 116 of x-rays 108 reflected from the structure 320. The reflected x-rays 108 scatter back to the x-ray detector 114, and are then transmitted to the processor 122 (FIG. 3) as described above for generating x-ray images 124 that are then analyzed by the processor 122 for detecting inconsistencies and nonconformances.

Referring to FIGS. 31-38, shown are examples of the positioning of the process tools 206 for hole formation and fastener installation 406. As mentioned above, each process tool 206 is movable along its shuttle axis 222 (FIG. 29) via the tool carrier tracks 220 for one-at-on-time positioning into alignment with the nose piece 204 in preparation for performing an operation on the structure 320.

FIGS. 31-32 show an example of a spindle 230 in alignment with the nose piece 204. The spindle 230 has been moved from its retracted position 224 to its extended position 226. The spindle 230 is rotatably driving a spindle tool 232 (e.g., a drill bit) and forming a countersunk fastener hole 402 in the structure 320.

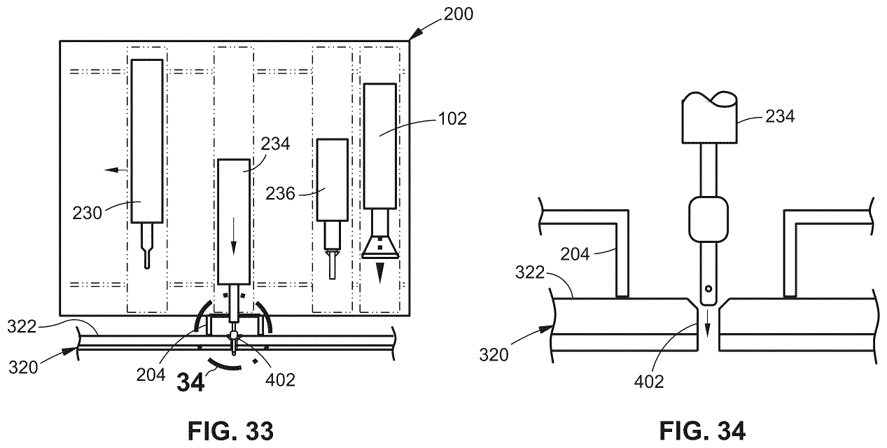

FIGS. 33-34 shows the hole probe 234 moved into alignment with the nose piece 204 after the spindle 230 has been moved out of alignment. The hole probe 234 is configured to measure at least one characteristic associated with a fastener hole 402 formed in the structure 320 by the drill bit. For example, the hole probe 234 can measure the hole diameter, the depth of the countersink 403, and/or the material stack thickness of the structure 320 at the location of the fastener hole 402.

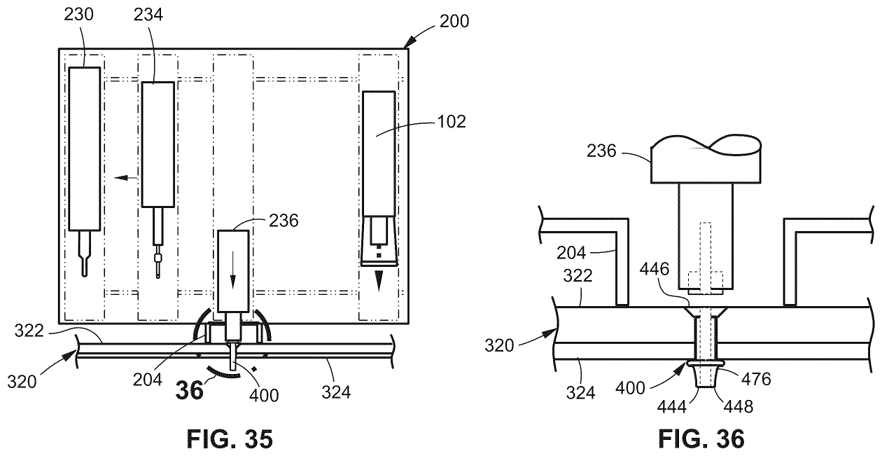

FIGS. 35-36 show an example of a fastener installer 236 moved into alignment with the nose piece 204 for installing a fastener 400 in the fastener hole 402 formed in the structure 320 by the spindle tool 232. In the example of FIGS. 35-36, the fastener 400 is a two-part fastener 444 in the form of a pin 446 and collar 448 combination (e.g., a Hi-Lok™ fastener). However, the fastener installer 236 can be configured to install any one of a variety of other types of fasteners 400 including, but not limited to, one-sided fasteners 418 such as the above-described sleeved fastener 420 of FIGS. 7-8. Additional examples of fasteners 400 that can be installed by the fastener installer 236 include temporary fasteners, twist-type fasteners, pull-type fasteners (e.g., blind rivets), and a variety of other types of fasteners 400 including a variety of other types of two-part fasteners 444.

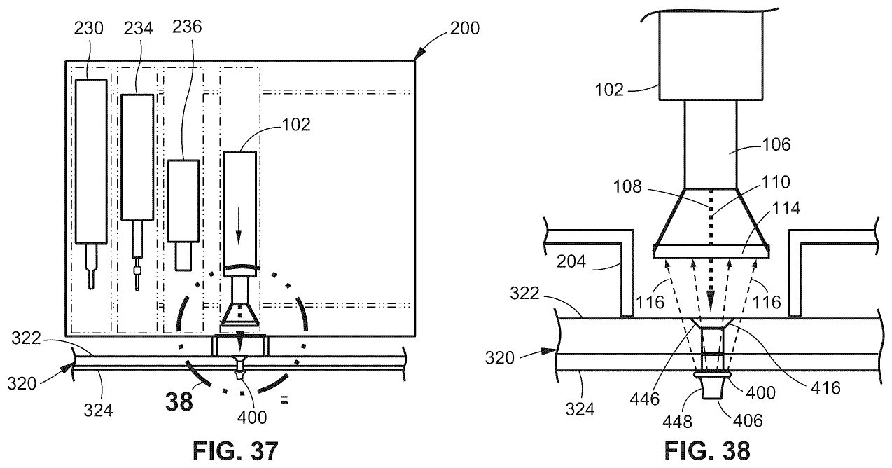

FIGS. 37-38 shows an example of the x-ray device 102 moved into alignment with the nose piece 204 for inspecting the fastener 400 installed by the fastener installer 236. Similar to the operation of the x-ray device 102 in FIG. 8, the x-ray device 102 in FIGS. 37-38 emits an x-ray beam 110 of x-rays 108, which penetrate the structure 320 and the fastener installation 406, and a portion of the x-rays 108 are reflected off of the pin 446 and the collar 448 and other components on the backside 324 of the structure 320. The backscatter 116 of x-rays 108 are detected by the x-ray detector 114 on the frontside 322 of the structure 320.

In any of the examples disclosed herein, the processor 122 can operate in an automated manner (i.e., without human intervention) to generate an x-ray image 124 based on the backscatter 116 detected by the x-ray detector 114 as described above with regard to FIG. 9. The x-ray image 124 can autonomously be displayed on a display screen of a computer 120 (FIG. 9). The processor 122 can also autonomously (i.e., without human intervention) compare the x-ray image 124 to a reference image 128 (e.g., FIG. 9) of a nominal version of the fastener installation 406, as described above, and detect potential inconsistencies and/or non-conformances 480 in the fastener installation 406. For example, the processor 122 can analyze and/or measure the diameter of a collar 448 and determine if the collar 448 is properly swaged on the pin 446. The processor 122 can also list on the display screen the collar dimensions (e.g., collar diameter) of the x-ray image 124 (i.e., the as-built diameter) and of the reference image 128 (i.e., the as-designed diameter).

The x-ray device 102 can perform other operations associated with the MFEE 200, and is not limited to inspecting fasteners 400. For example, the x-ray device 102 can inspect a fastener hole 402 after formation by the spindle 230 and prior to installation of the fastener 400 by the fastener installer 236. In this regard, the backscatter x-ray system 100 can analyze x-ray images 124 and determine whether the hole characteristics (e.g., hole diameter, countersink depth, etc.) conform to design requirements. Further in this regard, the x-ray device 102 can facilitate real-time monitoring of a variety of operations performed by any one of a variety of different types of process tools 206 that can be included with an MFEE 200.

Referring to FIG. 39-41, shown is an example of an MFEE 200 having an x-ray device 102 configured to monitor (e.g., in real time) one or more aspects of the process of installing fasteners 400 (FIG. 38) in a structure 320. In the example shown, the MFEE 200 includes the above-described process tools 206 of a spindle 230, a hole probe 234, and a fastener installer 236. The MFEE 200 additionally includes a touch-off probe 238, which is configured to inspect a fastener 400 after installation. For example, the touch-off probe 238 includes a probe element 240 for measuring the flushness of the fastener head 412 of a countersunk fastener 416 (FIG. 30) relative to the frontside 322 of the structure 320. Alternatively, the touch-off probe 238 can measure the protrusion of the fastener head 412 of a protruding head fastener (not shown) relative to the frontside 322.

In FIGS. 39-40, the x-ray device 102 is mounted to the end effector frame 202 in a manner such that the x-ray beam 110 is directed toward the working end 214 of the process tool 206 that is aligned with and/or positioned within the nose piece 204. Although the example shows the x-ray device 102 mounted on top of the end effector frame 202, the x-ray device 102 can be mounted at any location on the end effector frame 202 that allows the x-ray beam 110 to be directed toward the working end 214 of a process tool 206 when aligned with the nose piece 204. The x-ray device 102 is configured similar to the arrangement shown in FIGS. 5-6, and includes a spaced apart pair of x-ray detectors 114 that define a gap through which the x-ray beam 110 from the x-ray emitter 106 passes.

The backscatter x-ray system 100 (i.e., the x-ray device 102 and the processor 122) of FIGS. 39-40 is configured to generate x-ray images 124 (FIG. 17) in the form of a video feed of an operation performed by one of the process tools 206 of the MFEE 200. In the example of FIGS. 40-41, the x-ray device 102 emits x-rays 108 toward the frontside 322 of the structure 320 as the spindle 230 is forming a fastener hole 402. The backscatter 116 of x-rays 108 are reflected off the structure 320, enabling the processor 122 to generate an x-ray video feed of the drilling process. Although not shown, the video feed of x-ray images 124 can show at least one of the following operations on the display screen in real time: the application of coolant to the spindle tool 232 (i.e., drill bit or cutter) during formation of the fastener hole 402, the advancement of the drill bit through the structure 320, and/or the peck cycles in which the drill bit is periodically moved in and out of the fastener hole 402 to clear chips generated by the drill bit. In addition, the video feed of x-ray images 124 can detect if a drill bit breaks off during the drilling of a fastener hole 402, any metallic drill chips that are left behind after a fastener hole 402 is formed, and/or any drill chips that are present after a fastener 400 is installed in a fastener hole 402. As may be appreciated, the x-ray device 102 (and processor 122) can generate a video feed of x-ray images 124 showing any one of a variety of different aspects of the drilling process.

In some examples, the processor 122 of the backscatter x-ray system 100 can be configured to adjust the operating parameters of the process tools 206 based on the live x-ray video. For example, as the MFEE 200 clamps up against the structure 320 and the spindle 230 starts to form a fastener hole 402, the x-ray video can show the drill bit moving through the material of the structure 320 and, based off of predetermined gray patterns and/or gray density (not shown) in the x-ray images 124 that make up the video, the processor 122 can determine the type or composition of the material that is being drilled. The processor 122 can then adjust or adapt (e.g., in real time) one or more operating parameters of the spindle 230 based on the material composition of the structure 320. For example, the processor 122 can adjust (e.g., in real time) the feed rate and/or rotational speed of the drill bit as a means to extend the useful life of the drill bit and/or as a means to optimize the speed and/or quality of hole formation.

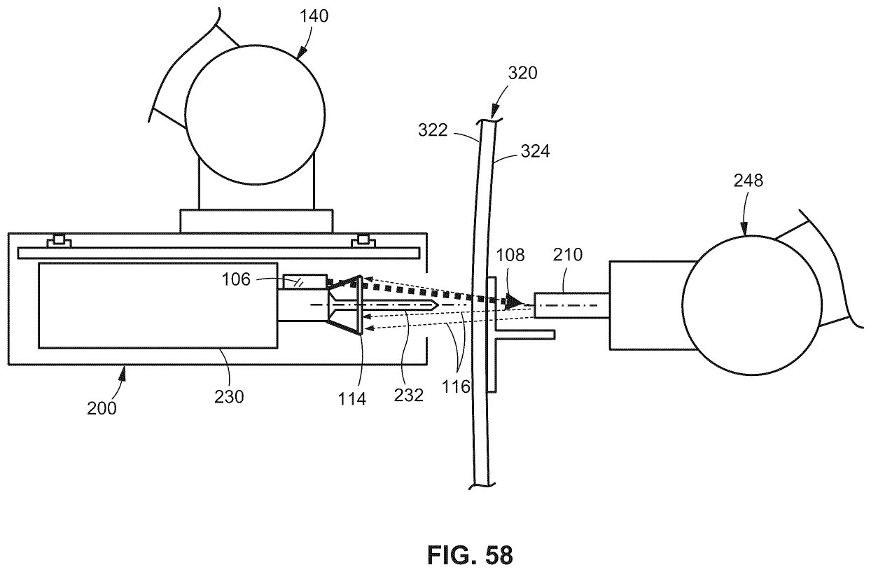

In addition to live monitoring of the formation of holes as described above, the backscatter x-ray system 100 can also generate a real time video feed of x-ray images 124 showing any one of a variety of other processes performed by an MFEE 200. For example, the backscatter x-ray system 100 can generate a video feed of x-ray images 124 that show the inspection of fastener holes 402 (e.g., by the hole probe 234), the inspection of the head end 410 or the tail end 428 of a fastener 400 (e.g., by the touch-off probe 238), the installation of sealant 462 (e.g., by a sealant applicator 248—FIG. 58), the sealant squeeze that occurs when sealant 462 between two structural components 330 is compressed during the tightening of fasteners 400, the deflection of the structure 320 during an operation performed by the MFEE 200, or any one of a variety of other processes.

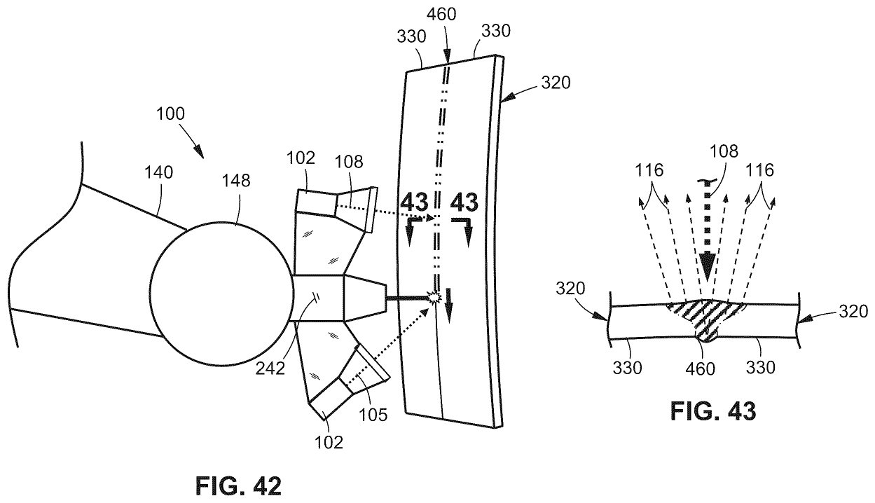

Referring to FIGS. 42-43, shown is an example of the backscatter x-ray system 100 in an arrangement for real time monitoring of the formation of a welding bead 460 on a structure 320. FIG. 42 shows a welding device 242 supported by a robotic arm 148. However, the welding device 242 can be mounted to other types of movable platforms 140, and is not limited to mounting to a robotic device 142. Also shown in FIGS. 42-43 are two x-ray devices 102, including include a first x-ray device 102 located on a forward side (e.g., a leading edge) of the welding device 242, and a second x-ray device 102 located on aft side (e.g., a trailing edge) of the welding device 242. Each x-ray device 102 is mounted in an off-angle orientation relative to a local normal to the frontside 322 surface of the structure 320. FIG. 43 shows the first and the second x-ray devices 102 emitting x-rays 108 and receiving the backscatter 116 of the x-rays 108 for monitoring the welding process. In such an arrangement, the processor 122 of the backscatter x-ray system 100 can continuously or periodically generate x-ray images 124 from each of the first and second x-ray devices 102, and continuously or periodically analyze and/or compare the x-ray images 124 to determine if the welding bead 460 conforms to design requirements.

For example, analysis of the gray pattern (not shown) or gray density (not shown) of the x-ray images 124 generated from the first x-ray device 102 on the forward side (e.g., leading edge) of the welding device 242 can establish the condition of the structure 320 prior to formation of the welding bead 460. Analysis of the x-ray images 124 generated from the second x-ray device 102 on the aft side (e.g., trailing edge) of the welding device 242 can detect the presence of cracks in the welding bead 460, gaps between the structural components 330 being welded together, and other characteristics of the welding bead 460 as mentioned above. The processor 122 can analyze the x-ray images 124 on a continuous basis as the welding device 242 forms the welding bead 460, or the analysis can be periodic (e.g., every 10th x-ray image). The processor 122 can also compare the x-ray images 124 of the first and second x-ray devices 102 to assess the before and after condition of the structure 320.

In some examples, the processor 122 of a backscatter x-ray system 100 of FIGS. 42-43 can set and/or adjust the operating parameters of the welding device 242 based on analysis of the x-ray images 124 of the first and second x-ray devices 102. For example, the processor 122 can perform a pre-inspection of the intended joint based on analysis of x-ray images 124 from the first and/or second x-ray device 102 to reveal the condition of the structural components 330 and the characteristics of the intended joint. Based on analysis of the x-ray images 124, the processor 122 can select an initial speed at which the movable platform 140 (e.g., the robotic device 142) moves the welding device 242 along the structure 320 to form the welding bead 460. During formation of the welding bead 460, the processor 122 can analyze a live feed of x-ray images 124 from the first and second x-ray devices 102, and adjust the operating parameters of the welding device 242. For example, if analysis of the x-ray images 124 indicates that the welding bead 460 is not penetrating the full thickness of the structure 320, the processor 122 can command the movable platform 140 (e.g., the robotic device 142) to reduce the speed of the welding device 242. After the welding bead 460 is completed, the first x-ray device 102 and/or second x-ray device 102 can be implemented to inspect the entirety of the welding bead 460.

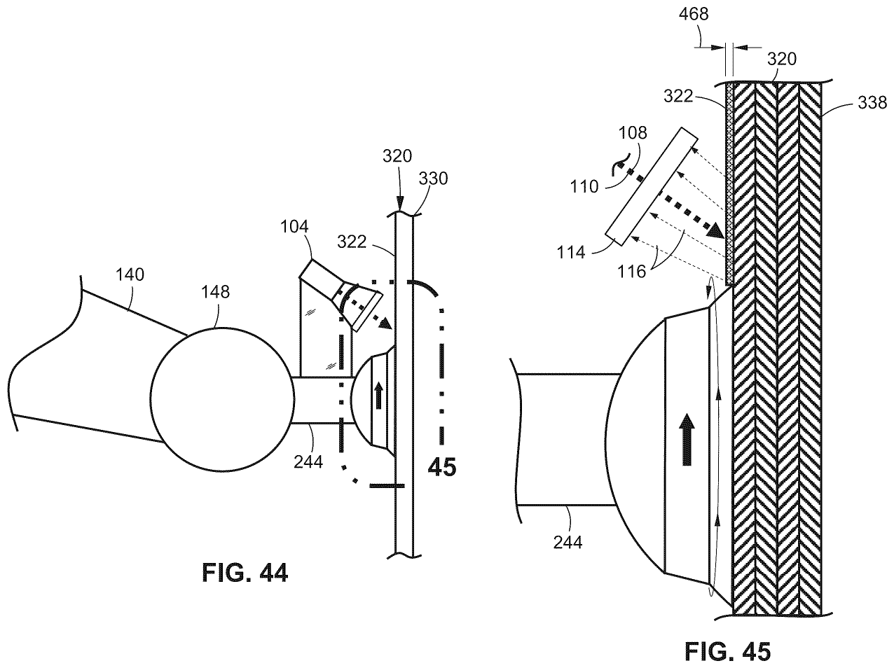

Referring to FIGS. 44-45, shown is an example of a surfacing device 244 for removing material from the frontside 322 of the structure 320. In the example shown, the surfacing device 244 is supported by a robotic arm 148 for moving the surfacing device 244 along the structure 320 while removing material. However, the surfacing device 244 can be supported by other types of movable platforms 140. The surfacing device 244 is configured to perform a surfacing operation such as sanding or polishing to remove a layer of material 468 from the structure 320. An off-axis x-ray device 104 is included with the surfacing device 244 for monitoring the surfacing operation performed on the structure 320.

Although not shown in FIG. 44, a processor 122 (FIG. 3) generates x-ray images 124 from a backscatter 116 of x-rays 108 reflected off the structure 320, similar to the above-described example of FIG. 3. The processor 122 analyzes the x-ray images 124 to ensure that only a top layer of material 468 is removed from the structure 320. For example, the structure 320 may be a composite structure 338 having an outer layer of non-structural material such as a conductive mesh. The processor 122 compares the x-ray images 124 to reference images 128 to determine the composition of the material removed by the surfacing device 244. In this manner, the processor 122 ensures that only the conductive layer is removed and that the structural layers (e.g., composite plies) underneath the conductive layer are not removed. If the processor 122 detects that not all of the conductive layer is being removed by the surfacing device 244, or if the processor 122 detects that structural layers are being removed along with the conductive layer, the processor 122 can adjust one or more operating parameters of the surfacing device 244 and/or the movable platform 140 in a manner to ensure that only the conductive layer is removed by the surfacing device 244, and none of the structural layers are removed.

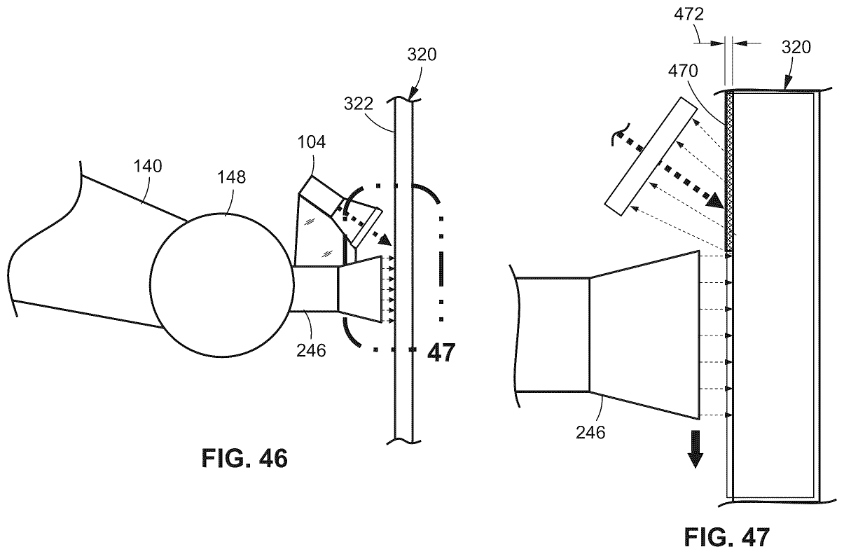

Referring to FIGS. 46-47, shown is an example of a coating applicator 246 for applying a coating 470 to the frontside 322 of a structure 320. In the example shown, the coating applicator 246 is supported by a robotic arm 148 for moving the coating applicator 246 along the structure 320 while applying a coating 470. Alternatively, the coating 470 application can be supported by other types of movable platforms 140. An off-axis x-ray device 104 is included with the coating applicator 246 for monitoring the coating application process.

Similar to the above-described arrangement for the surfacing device 244, a processor 122 (FIG. 3) is coupled to the off-axis x-ray device 104 of FIG. 46. The processor 122 generates x-ray images 124 from a backscatter 116 of x-rays 108 reflected off the coating 470 during application by the coating applicator 246. The processor 122 continuously or periodically analyzes the x-ray images 124 to determine the thickness of the coating 470. If the processor 122 detects that the coating thickness 472 is not in conformance with established coating requirements, the processor 122 adjusts one or more operating parameters of the coating applicator 246 and/or the movable platform 140 so that the coating thickness 472 meets the coating requirements.

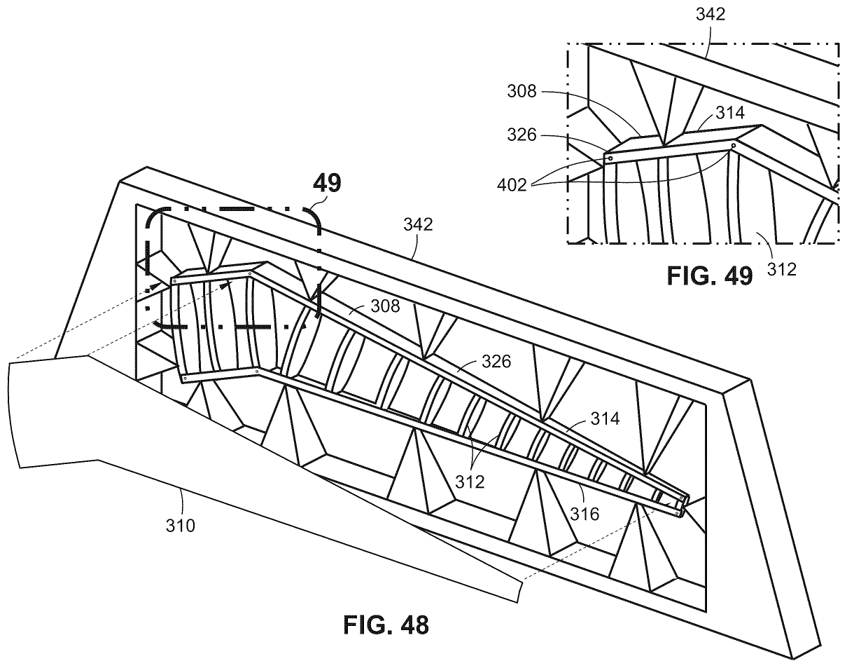

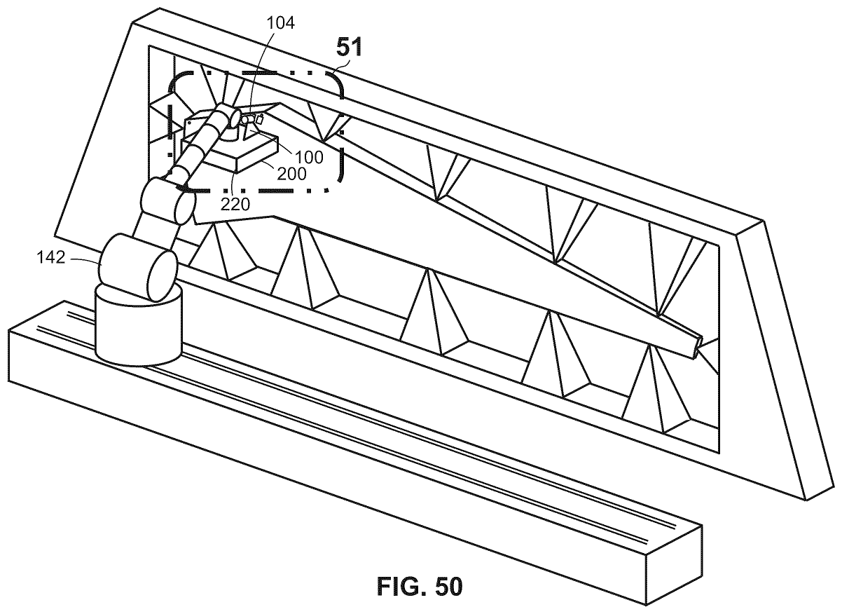

Referring to FIG. 48, shown is the wing box 308 of FIG. 3 during the process of loading one of the skin panels 310 onto the wing box 308 substructure 326 (e.g., spars 314, 316 and wing ribs 312) while supported by the assembly fixture 342. The conventional method of locating a structural component 330, such as a skin panel 310, onto a substructure 326, such as a wing box 308, involves providing the skin panel 310 with pilot holes (e.g., fastener holes 402), positioning the skin panel 310 against the substructure 326, drilling through the pilot holes from the frontside 322 of the skin panel 310 and into the substructure 326, and installing temporary fasteners to secure the skin panel 310 to the substructure 326. The process can be performed with an MFEE 200 that can autonomously detect (via a vision system—not shown) the locations of the pilot holes in the skin panel 310 and transfer them into the substructure 326. However, for structures 320 in which pilot holes are provided only in the substructure 326 and not in the skin panel 310, current methods do not allow for locating the pilot holes in the substructure 326 from the frontside 322 of the structure 320, as the pilot holes are hidden from view by the skin panel 310. FIG. 49 is a magnified view of a portion of the wing box 308 without the skin panel 310, and showing an example of pilot holes (e.g., fastener holes 402) in the substructure 326.

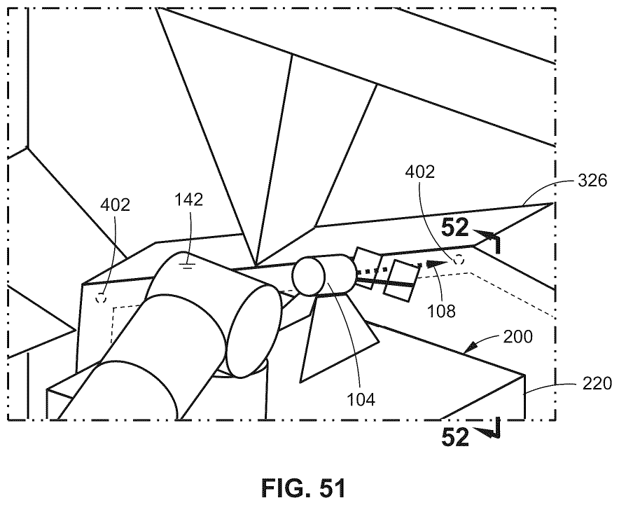

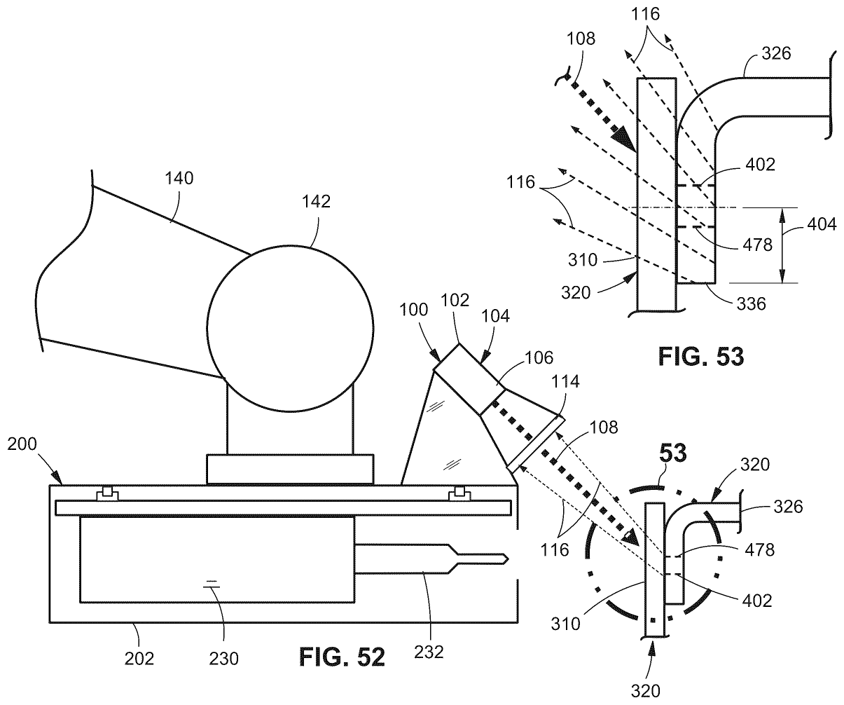

Referring to FIGS. 50-53, shown is an example of an MFEE 200 supported by a robotic device 142. The MFEE 200 has a backscatter x-ray system 100 having an off-axis x-ray device 104 mounted to the end effector frame 202, and which is configured to detect pilot holes in the substructure 326 for the purpose of aligning the MFEE 200 with the pilot holes (e.g., fastener holes 402). For example, in FIGS. 52-53, the off-axis x-ray device 104 emits x-rays 108 and detects a backscatter 116 of x-rays 108 reflected off the substructure 326 (FIG. 53). A processor 122 (e.g., FIG. 3) generates x-ray images 124 of the substructure 326 based on the backscatter 116, and the x-ray images 124 show the location of the pilot hole relative to the current position of the MFEE 200. The processor 122 then commands the movable platform 140 (e.g., robotic device 142) to adjust the position of the MFEE 200 such that the nose piece 204 (not shown) of the MFEE 200 is aligned with (e.g., centered on) the pilot hole, after which the spindle 230 drills a fastener hole 402 through the skin panel 310 in alignment with the pilot hole. The MFEE 200 can then install a tack fastener, a temporary fastener, or a permanent fastener in the fastener hole 402 in an automated manner to secure the skin panel 310 in position on the substructure 326.

In addition to using the backscatter x-ray system 100 to align the MFEE 200 to pilot holes in the substructure 326, the backscatter x-ray system 100 can also detect vision points 478 in a substructure 326 for the purpose of adjusting the position of the MFEE 200 prior to forming fastener holes 402 in the structure 320 according to an engineering hole pattern. Vision points 478 can include any one of a variety of different types of features of the structure 320, including substructure features such as pilot holes (e.g., fastener holes 402) and part edges 336 (e.g., FIGS. 52-53) in the substructure 326. The vision point 478 can be acquired by the backscatter x-ray system 100 using the x-ray device 102 and processor 122 in the same manner as described above. Once the backscatter x-ray system 100 acquires the vision points 478, the processor 122 adjusts the position of the MFEE 200 relative to the substructure 326 such that the MFEE 200 on the frontside 322 can drill an engineering hole pattern with assurance that each of the fastener holes 402 in the substructure 326 will have proper edge distance 404, despite the inability to visually observe the edge distances 404 of fastener holes 402 in the substructure 326 due to the skin panel 310 covering the substructure 326.

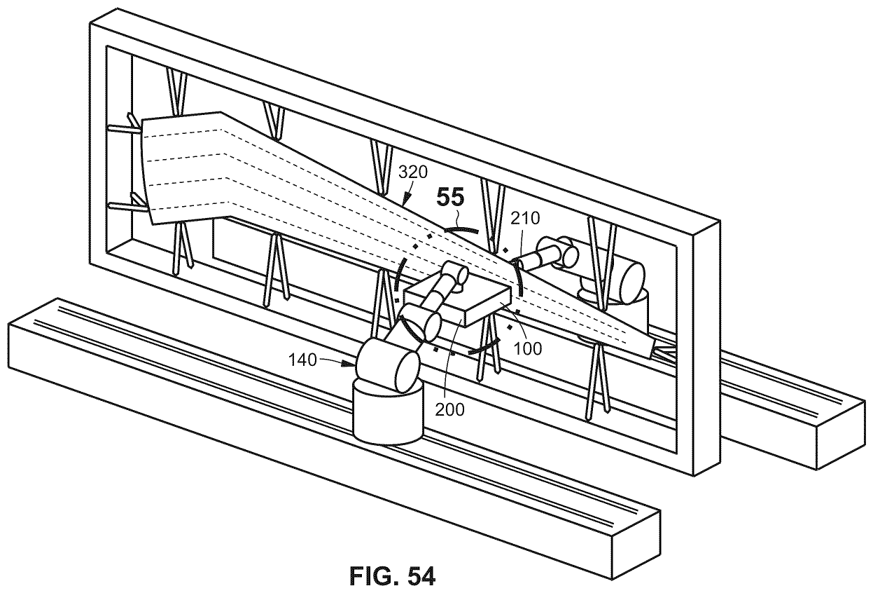

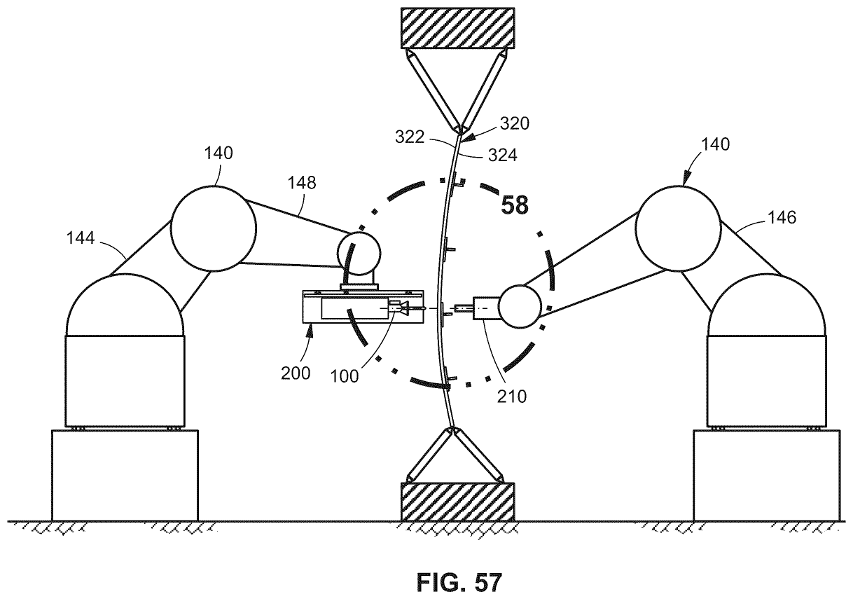

Referring to FIGS. 54-58, shown in FIGS. 54 and 57 is an example of an MFEE 200 having a backscatter x-ray system 100 for detecting the location of a backside process tool 210 on the backside 324 of a structure 320. In the example shown, the MFEE 200 on the frontside 322 of the structure 320 is supported by a frontside robot 144. A backside robot 146 supports the backside process tool 210. Although robotic devices 142 are shown supporting the MFEE 200 and the backside process tool 210, any one of a variety of other types of movable platforms 140 (e.g., a CNC machine 154) can be used to respectively support the MFEE 200 and the backside process tool 210.

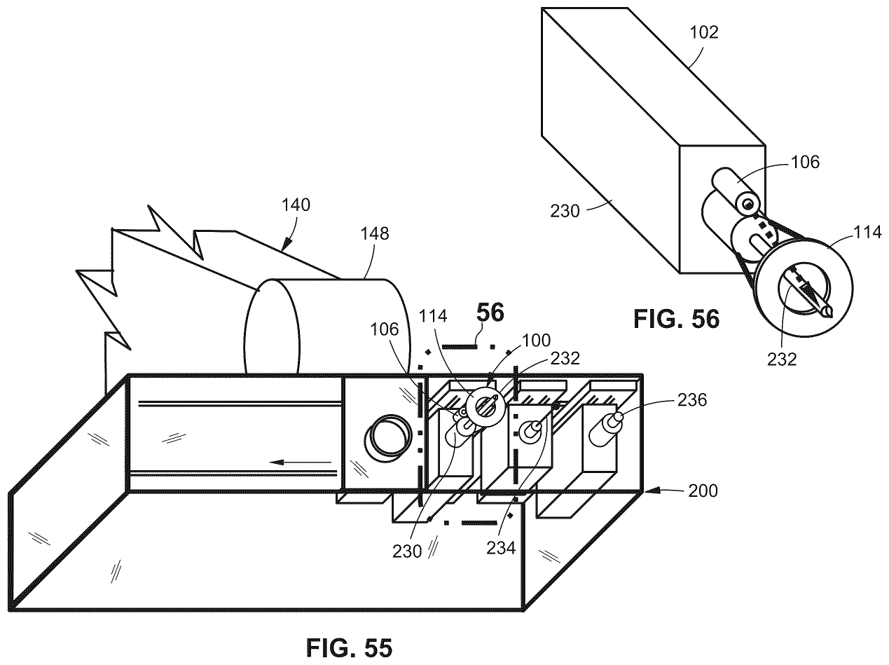

In FIG. 55, the process tools 206 of the MFEE 200 include a spindle 230, a hole probe 234, and a fastener installer 236. In the example of FIG. 55, an x-ray device 102 is incorporated into the spindle 230. FIG. 56 shows one example in which the x-ray device 102 is generally aligned with the spindle tool 232. The x-ray device 102 includes an x-ray emitter 106 mounted in close proximity to the spindle 230. The x-ray device 102 also includes an x-ray detector 114 supported by the x-ray emitter 106. The x-ray detector 114 has a disc shape having an opening that is concentric with the spindle tool 232. The x-rays 108 emitted by the x-ray emitter 106 are configured to pass through the opening in the x-ray detector 114. However, the x-ray detector 114 can have any one of a variety of alternative configurations and is not limited to a single disc-shaped x-ray detector 114 having a central opening that is concentric with the spindle tool 232.

The backside process tool 210 is configured to operate in coordination with one of the process tools 206 of the MFEE 200 to perform an operation on the structure 320. For example, before, during, or after the MFEE 200 clamps up to the frontside 322 of the structure 320 and the spindle 230 drills a fastener hole 402, the nose piece 204 of the MFEE 200 remains clamped up to the structure 320 while the x-ray emitter 106 of the x-ray device 102 emits x-rays 108 that penetrate the structure 320 and reflect off the backside process tool 210. As shown in FIG. 58, the x-ray detector 114 detects a backscatter 116 of the reflected x-rays 108. The processor 122 (not shown) generates x-ray images 124 (e.g., FIG. 9) based on the backscatter 116, and analyzes the x-ray images 124 to determine the location of the backside process tool 210 relative to the MFEE 200. The processor 122 can use positional feedback from the x-ray images 124 to adjust the position of the backside process tool 210 relative to the MFEE 200, or adjust the position of the MFEE 200 backside process tool 210 relative to the backside process tool 210. For example, if the backside process tool 210 is misaligned with the nose piece 204 of the MFEE 200, the processor 122 commands the movable platform 140 (e.g., robotic device 142) of the backside process tool 210 to move the backside process tool 210 into alignment with the MFEE 200.

With the backside process tool 210 aligned with the MFEE 200 which is still clamped up against the structure 320, the fastener installer 236 can be moved into position with the nose piece 204, and a fastener 400 installed in the fastener hole 402. For example, the fastener 400 can be a two-part fastener 444 such as pin 446 and collar 448 combination (e.g., Hi-Lok™ fasteners 400) as shown in FIGS. 19-20. The backside process tool 210 on the backside 324 of the structure 320 can swage the collar 448 onto the pin 446 while the fastener installer 236 holds the pin 446 in place on the frontside 322 of the structure 320. However, other types of fasteners 400 such as rivets (not shown) can be installed using the above-described process by using the backside process tool 210 to form (i.e., buck) the tail end 428 of the rivet on the backside 324 of the structure 320. The backscatter x-ray system 100 can provide feedback during the bucking process by analyzing x-ray images 124 to confirm that the tail end 428 of the rivet is properly formed and is seated correctly. As may be appreciated, the above-described arrangement can be implemented for any one of a variety of different types of process tools 206 where alignment with a backside process tool 210 is necessary, and the arrangement is not limited to a fastener installer 236 of an MFEE 200.

Advantageously, any one of the backscatter x-ray system 100 configurations disclosed herein can be used to facilitate the manufacturing and inspection of a structure 320 with repeatable accuracy. For example, the backscatter x-ray system 100 can periodically or continuously generate and analyze x-ray images 124 of the structure 320, and compare the x-ray images 124 to reference images 128 of an as-designed digital model 130 of the structure 320 during manufacturing for inspection. The processor 122 can flag or record differences that exist between the x-ray images 124 and the reference images 128 as possible non-conformances 480.

Each flagged difference can be recorded along with its three-dimensional location (e.g., x, y, z coordinates) relative to a reference point such as a predetermined origin of a reference coordinate system 344 (FIGS. 3-4) at a known location of the structure 320, such as the corner of a skin panel 310. Because the x-ray device 102 is positioned by the robotic device 142 (or machine 152) at a known location when generating x-ray images 124 based on backscatter 116 data, the robotic device (or machine) can record highly accurate positional data of the exact location on the structure 320 where the x-ray images 124 were taken. In this regard, the processor 122 can flag differences between x-ray images 124 and reference images 128, and their three-dimensional locations relative to a predetermined reference point on the structure 320 for any one of the following features or characteristics: fastener holes 402, fastener installations 406, gaps between structural components 330, sealant installations, welding beads 460, material stackup, material characteristics, and any one of a variety of other aspects of a structure 320. The processor 122 can also be configured to flag and record one or more (e.g., all) of the aspects of the structure 320 that conform with design requirements, as well as their three-dimensional locations relative to a predetermined reference point. In addition, any one or more of the functionalities and capabilities of any examples of the x-ray device 102 and/or the processor 122 described herein can be implemented in any one of the disclosed arrangements of the backscatter x-ray system 100, including any of the arrangements of FIGS. 3-6, 14-15, 24-27, 28-38, 39-47, 50-52, and 54-58.

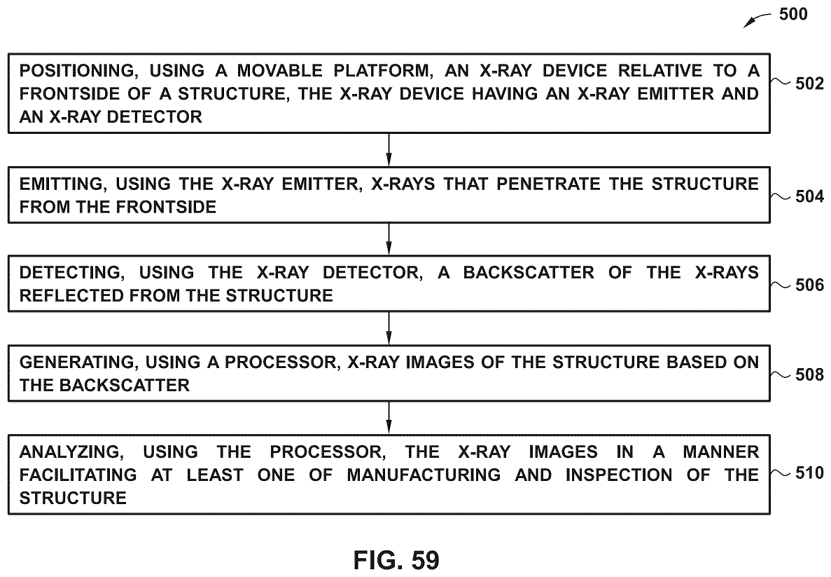

Referring to FIG. 59, shown is a flowchart of operations included in an x-ray inspection method 500. For example, as described in greater detail below, the method 500 can be implemented for inspecting various aspects associated with a structure 320 including, but not limited to, fastener installations 406, sealant 462 installations, coating 470 applications, welding beads 460, gaps between structural components 330, and aspects associated with the material of a structure 320 such as material stack up, material characteristics, and material composition. In addition, the method 500 can be implemented for monitoring one or more processes and operations performed on a structure 320, including, but not limited to, forming fastener holes 402, installing fasteners 400, performing inspections, installing sealant 462, forming welding beads 460, applying coatings 470, and performing surface operations on a structure 320 such as sanding and machining. Furthermore, the method 500 can be implemented to facilitate the process of locating a structural component 330, such as a skin panel 310, relative to a substructure 326, and the process of locating a backside process tool 210 relative to a process tool 206 or MFEE 200 on the frontside 322 of the structure 320, as described in greater detail below.

Step 502 of the method 500 includes positioning, using a movable platform 140, an x-ray device 102 relative to a frontside 322 of a structure 320. As described above, the x-ray device 102 is a backscatter 116 x-ray device 102 having an x-ray emitter 106 and an x-ray detector 114. The x-ray device 102 is mounted to the movable platform 140, which is configured to dynamically and statically position and/or orient the x-ray device 102 relative to the frontside 322 of the structure 320. The movable platform 140 is configured to position the x-ray device 102 in non-contacting relation to the frontside 322 to allow enough distance for the x-rays 108 to interact with the structure 320 and for the backscatter 116 of x-rays 108 to be detected by the x-ray detector 114.

In some examples, step 502 of positioning the x-ray device 102 relative to the frontside 322 of the structure 320 comprises positioning the x-ray device 102 using a robotic device 142, a robotic arm 148, a machine 152, a CNC machine 154, or any one of other types of movable platforms 140 capable of positioning the x-ray device 102 relative to structure 320. As mentioned above, the movable platform 140 may be configured to move along a floor-mounted track or an overhead gantry to allow the x-ray device 102 to be positioned at any location on a structure 320. In one specific example, the x-ray device 102 can be mounted on the end of a robotic arm 148 of a robotic device 142, which is movable along robotic device tracks 150. Alternatively, a movable platform 140 such as a robotic device 142 may be mounted to an overhead gantry (not shown) or mounted on any other type of movable platform 140 capable of positioning the x-ray device 102 relative to a structure 320.

In one example, step 502 of positioning the x-ray device 102 using the movable platform 140 to position the x-ray device 102 such that the beam central axis 112 of the x-ray beam 110 is oriented according to the following: parallel to the fastener centerline 408 of a fastener installation 406 in the structure 320, or non-parallel to the fastener centerline 408. Orienting the x-ray device 102 such that the beam central axis 112 is parallel to the fastener centerline 408 may be desirable when performing inspections such as the diameter and/or roundness of a fastener hole 402, or inspecting the concentricity of collar 448 swaged onto tail end 428 of pin 446. A non-parallel orientation of the beam central axis 112 is desirable when performing other operations including, but not limited to, inspecting the material stack up or material characteristics of a structure 320, checking for a head-to-structure gap 484 between a fastener head 412 and the frontside 322 of the structure 320, and checking for a receptacle-to-component gap between a receptacle 440 and a backside 324 of the structure 320, and other operations. The x-ray device 102 can also be oriented such that its beam central axis 112 is locally perpendicular to the frontside 322 surface of the structure 320, or locally non-perpendicular to the frontside 322 surface of the structure 320.

In some examples, step 502 of positioning the x-ray device 102 relative to the frontside 322 of the structure 320 comprises supporting the x-ray device 102 and a plurality of process tools 206 on an end effector frame 202 of an MFEE 200. As described above, the end effector frame 202 is typically coupled to a movable platform 140 such as a machine 152 or a robotic device 142. As noted above, the process tools 206 of an MFEE 200 are configured to perform different operations in relation to the structure 320. For example, an MFEE 200 can include process tools 206 such as a spindle 230, a hole probe 234, a fastener installer 236, and a touch-off probe 238. As described above, the spindle 230 of an MFEE 200 rotatably drives a spindle tool 232 for forming a fastener hole 402 in the structure 320. The hole probe 234 measures at least one characteristic associated with the fastener hole 402. The fastener installer 236 installs a fastener 400 in the fastener hole 402. The touch-off probe 238 measures at least one characteristic associated with a fastener 400 installed in the structure 320. Additional or alternative types of process tools 206 that can be included with an MFEE 200, such as a sealant applicator 248 (FIG. 58), a coating applicator 246 (FIG. 46-47), a welding device 242 (FIGS. 42-43), and any one of a variety of other types of process tools 206.

In the example described above, the end effector frame 202 includes a nose piece 204 configured to be engaged to the frontside 322 of the structure 320. The process tools 206 each have a tool axis 216 and are arranged in side-by-side relation to each other in the end effector frame 202. The method 500 includes moving the process tools 206 along a shuttle axis 222 for one-at-a-time alignment with the nose piece 204. Once aligned with the, the method 500 includes moving each process tools 206 along its tool axis 216 from a retracted position 224 in which the working end 214 of the process tool 206 is spaced apart from the structure 320, and an extended position 226 in which the working end 214 of the process tool 206 is in close proximity to the structure 320 to allow the process tool 206 to perform an operation in relation to the structure 320.

Step 504 of the method 500 includes emitting, using the x-ray emitter 106 of the x-ray device 102, x-rays 108 that penetrate a structure 320 from the frontside 322. As described above, the x-rays 108 penetrate or pass through the structure 320 in a first general direction away from the device. When the emitted x-rays 108 encounter features of the structure 320 such as internal features 474 and/or backside features 476 (including fasteners 400 installations), the x-rays 108 reflect off the surfaces of the features and are directed back toward the x-ray device 102.

Step 506 of the method 500 includes capturing or detecting, using the x-ray detector 114 of the x-ray device 102, photons in a backscatter 116 of the x-rays 108 reflected off the features of the structure 320. As described above, at least a portion of the x-rays 108 emitted by the x-ray emitter 106 reflect or scatter back to the x-ray detector 114 located on the frontside 322. The backscatter 116 of x-rays 108 pass back through the structure 320 in a second general direction opposite the first general direction.

Step 508 of the method 500 includes generating, using a processor 122, x-ray images 124 of the structure 320 based on the backscatter 116 of x-rays 108 detected by the x-ray detector 114 of the x-ray device 102. As described above, the processor 122 is communicatively coupled to the x-ray device 102. For example, the processor 122 can be integrated into a computer 120 such as a laptop located in close proximity to the x-ray device 102. In other examples, the processor 122 can be integrated into the x-ray device 102 itself. Regardless of its location relative the x-ray device 102, the processor 122 contains software that processes data from the x-ray detector 114 regarding backscattered x-rays 108. In some examples, the processor 122 also controls the operation of the movable platform 140 and/or the operation of the x-ray device 102. For example, the processor 122 controls the movable platform 140 for positioning and/or orienting the x-ray device 102 relative to the structure 320 prior to, during, or after the x-ray device 102 emits x-rays 108 toward the structure 320 and subsequently detects the backscatter 116 of x-rays 108.

Step 510 of the method 500 includes analyzing, using the processor 122, the x-ray images 124 in a manner facilitating manufacturing and/or inspection of a structure 320. For example, step 510 can include analyzing the x-ray images 124 in a manner facilitating the detection of one or more characteristics associated with one or more aspects or features of the structure 320. In one example, the processor 122 analyze the x-ray images 124 and detect inconsistencies and/or non-conformances 480 in, of, and/or on one or more aspects, features, or characteristics associated with the structure 320. In this regard, the processor 122 determines whether an aspect of the structure 320 is in conformance with design requirements.

For example, step 510 of the method 500 comprises analyzing the x-ray images 124 and detecting inconsistencies in at least one of the following described above: a fastener installation 406 in the structure 320, a sealant 462 applied to the structure 320, a coating 470 applied to the structure 320, a welding bead 460 in the structure 320, a material characteristic of the structure 320, a material stackup of the structure 320, and a structural assembly gap 482 between structural components 330 of the structure 320.

In one example, step 510 of analyzing the x-ray images 124 to detect inconsistencies comprises comparing x-ray images 124 of the structure 320 to an as-designed model of the structure 320 to detect non-conformances 480. For example, referring to FIGS. 9 and 17, step 510 of the method comprises using the processor 122 to compare x-ray images 124 to reference images 128 generated from or based on an as-designed model to determine whether an aspect of the structure 320 is in conformance with design requirements. Alternatively or additionally, the processor 122 compares the x-ray images 124 to a reference image 128 of a nominal version of the fastener installation 406 to determine conformance with design requirements. In a further example, the processor 122 compares the x-ray images 124 to a dataset of nominal dimensions associated with the structure 320 to detect non-conformances 480.

In addition to detecting inconsistencies in a structure 320, step 510 can include analyzing x-ray images 124 to facilitate the manufacturing of the structure 320. For example, as described above with regard to FIGS. 48-53, step 510 can include analyzing x-ray images 124 to detect the presence of a vision point 478 such as a fastener hole 402 (e.g., a pilot hole) in a substructure 326 for the purpose of positioning a structural component 330 such as a skin panel 310 relative to the substructure 326. Another example includes analyzing x-ray images 124 to acquire a vision point 478 in the substructure 326 for use in positioning a process tool 206 relative to the vision point 478. For example, step 510 can include analyzing the x-ray images 124 to detect a fastener hole 402 (e.g., a pilot hole) in the substructure 326 for the purpose of aligning a spindle 230 with a centerline of the fastener hole 402, as described above with regard to FIGS. 52-53.

Still further examples of step 510 include analyzing x-ray images 124 for the purpose of positioning a process tool 206 on the frontside 322 of the structure 320 relative to (e.g., in alignment with) a process tool 206 on the backside 324 of the structure 320, as shown in the above-described FIGS. 54-58. If the backside process tool 210 is misaligned with the frontside process tool 208, the method 500 additionally includes commanding a movable platform 140 (e.g., a backside robot 146) to move the backside process tool 210 into alignment with the frontside process tool 208. Alternatively or additionally, the method 500 includes commanding a frontside 322 movable platform 140 (e.g., a frontside robot 144) to move the process tool 206 and the frontside 322 into alignment with the backside process tool 210.

Another example of step 510 of analyzing the x-ray images 124 for manufacturing purposes includes acquiring vision points 478 for the purpose of positioning a hole pattern on the frontside 322 of the structure 320 based on the location of a vision point such as a pilot hole or part edge 336 of the substructure 326. For example, step 510 can include analyzing x-ray images 124 to acquire vision points 478 in the substructure 326, and using the vision points 478 to adjust the position of an MFEE 200 on the frontside 322 relative to the substructure 326 in a manner such that the MFEE 200 can drill a hole pattern from the frontside 322 with assurance that each of the fastener holes 402 in the substructure 326 will have proper edge distance 404.

Additional examples of step 510 include analyzing x-ray images 124 to facilitate the monitoring of manufacturing operations performed on the structure 320 and/or the subsequent inspection of the structure 320 after completion of the manufacturing operations. For example, as described above, the method 500 can include generating x-ray images 124 in the form of a live video feed of an operation performed by a process tool 206 of an MFEE 200. As shown in the above-described FIGS. 40-41, the processor 122 can generate an x-ray video feed of a spindle tool 232 (e.g., drill bit) drilling a fastener hole 402 in the structure 320. The video feed can be observed by a technician and can show different aspects of the drilling process including the application of coolant to the drill bit, the advancement of the drill bit through the structure 320, and peck cycles of the drill bit. At completion of the fastener hole 402, step 510 can additionally include analyzing x-ray images 124 to generate a video feed showing the process of inspecting the hole, such as by using a touch-off probe 238 as described above.

Step 510 of analyzing x-ray images 124 can additionally include generating an x-ray video feed for the purpose of monitoring operations such as installing fasteners 400 in fastener holes 402, and monitoring the inspection of the fastener 400 after installation in the structure 320. Additional operations that can be performed include monitoring the installation of a sealant 462 on the structure 320 (e.g., observing sealant squeeze during tightening of the fastener), and inspecting the sealant 462 after installation. Furthermore, the process of analyzing x-ray images 124 in step 510 can include generating an x-ray video feed for the purpose of monitoring the formation of a welding bead 460 on the structure 320 by a welding device 242 on the frontside 322, and the subsequent inspection of the welding bead 460 after completion, as described above. Step 510 can additionally include generating an x-ray video feed for the purpose of monitoring the amount of material removed from the frontside 322 of the structure 320 using a surfacing device 244.

In any of the examples disclosed herein, the method 500 can include displaying, in real time, the x-ray images 124 on the display screen of the computer 120. For example, the method can include displaying still x-ray images 124 and/or an x-ray video feed of any one of the above-described manufacturing and/or inspection operations to allow for real-time visual monitoring of the operations by a technician. In some examples, step 510 of analyzing the x-ray images 124 is performed in a manner facilitating the adjustment of one or more tool operating parameters of a corresponding process tool 206 located on the frontside 322 of the structure 320. Adjustment of tool operating parameters can be performed manually or in an automated manner by the processor 122 based on analysis of the x-ray images 124. Adjustment of the tool operating parameters can occur before, during, and/or after the performance of an operation by a process tool 206. For example, analysis and/or monitoring of x-ray images 124 when forming a fastener hole 402 in a structure 320 can facilitate manual or automated adjustment of the feed rate at which the spindle tool 232 (e.g., drill bit) advances into the structure 320 or the rotational speed of the spindle 230 when forming the fastener hole 402. For example, based on the gray patterns and/or gray density (not shown) in the x-ray images 124 in a video feed, the processor 122 can determine the composition of the material of the structure 320, and adjust or adapt the feed rate and/or rotational speed of the drill bit as a means to extend the useful life of the drill bit.

When installing a fastener 400 in a fastener hole 402, analysis of the gray patterns and/or gray density in x-ray images 124 generated by a backscatter x-ray system 100 can include adjusting a torque level applied to the fastener 400 by a fastener installer 236 in a manner to ensure that the receptacle 440 applied to the tail end 428 of the fastener 400 meets design requirements. For example, during installation of a series of sleeved fasteners 420 in fastener holes 402, analysis of the gray patterns and/or gray density in x-ray images 124 can facilitate the automated adjustment by the processor 122 of the torque level applied to each sleeved fastener 420 by the fastener installer 236 to ensure that the bulb dimensions (e.g., bulb diameter 438) of the sleeve bulb 436 of each sleeved fastener 420 meets design requirements.

In another example, analysis of the x-ray images 124 generated by a backscatter x-ray system 100 can include adjusting the travel path and/or travel speed of a coating applicator 246 in applying a coating 470 to the structure 320, as described above with regard to FIGS. 46-47. For example, based on the gray patterns and/or gray density in still x-ray images 124 or an x-ray video feed of a coating 470 applied to a structure 320 by a coating applicator 246, the processor 122 can determine the thickness with which the coating 470 is applied, and adjust or adapt the travel speed of the coating applicator 246 to maintain the coating thickness 472 within established design requirements. In a still further example, analysis of x-ray images 124 generated by a backscatter x-ray system 100 can include adjusting the tool operating parameters of a welding device 242 in forming a welding bead 460 joining structural components 330 of a structure 320, as described above with regard to FIGS. 42-43. For example, during the formation of a welding bead 460, the processor 122 can analyze the gray patterns and/or gray density in x-ray images 124 generated by first and second x-ray devices 102 located respectively forward and aft of a welding device 242, and adjust the speed with which a movable platform 140 (e.g., a robotic device 142) moves the welding device 242 along the structure 320, to thereby ensure penetration of the welding bead 460 through the full thickness of both structural components 330.

Many modifications and other versions and examples of the disclosure will come to mind to one skilled in the art to which this disclosure pertains having the benefit of the teachings presented in the foregoing descriptions and the associated drawings. The versions and examples described herein are meant to be illustrative and are not intended to be limiting or exhaustive. Although specific terms are employed herein, they are used in a generic and descriptive sense only and not for purposes of limitation. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled.

What is claimed is:

1. A backscatter x-ray system, comprising:
an x-ray device having an x-ray emitter and an x-ray detector;
a movable platform configured to position the x-ray device relative to a frontside of a structure; and
a processor communicatively couplable to the x-ray device;
wherein:
the x-ray emitter is configured to emit x-rays that penetrate the structure from the frontside;
the x-ray detector is configured to detect a backscatter of the x-rays reflected from the structure; and
the processor is configured to generate x-ray images of the structure based on the backscatter, and analyze the x-ray images in a manner facilitating at least one of manufacturing and inspection of the structure.

2. The backscatter x-ray system of claim 1, wherein the processor is configured to analyze the x-ray images in a manner detecting inconsistencies in one or more aspects of the structure, the aspects comprising at least one of the following:
a fastener installation in the structure;
a coating applied to the structure;
a sealant applied to the structure;
a welding bead in the structure;
a material characteristic of the structure;
a material stackup of the structure; and
a gap between structural components of the structure.

3. The backscatter x-ray system of claim 1, wherein the processor is configured to analyze the x-ray images in a manner detecting one more of the following inconsistencies in a fastener installation:
a non-conforming sleeve bulb on a tail end of a one-sided fastener;
a missing collar on a tail end of a one-sided fastener;
a non-conforming swage of the collar on the tail end of the one-sided fastener;
a missing receptacle on the tail end of a two-part fastener;
a non-conforming installation of the receptacle on the tail end of the two-part fastener; and
a gap between a fastener head and the frontside of structure.

4. The backscatter x-ray system of claim 1, wherein:
the x-rays emitted by the x-ray emitter define an x-ray beam that has a beam central axis;
the movable platform is configured to position the x-ray device such that the beam central axis is orientable according to at least one of the following:
parallel to a fastener centerline of a fastener installation in the structure;
non-parallel to the fastener centerline of the fastener installation;
locally perpendicular to a frontside surface of the structure; and
locally non-perpendicular to the frontside surface.

5. The backscatter x-ray system of claim 1, wherein the movable platform is one of the following:
a robotic device, a robotic arm, a machine, a CNC machine.

6. The backscatter x-ray system of claim 1, further comprising:
an end effector frame of a multi-function end effector configured to be mounted to the movable platform;
a plurality of process tools mountable to the end effector frame and configured to perform different operations in relation to the structure; and
the x-ray device is mounted to the end effector frame adjacent to one or more of the process tools.

7. The backscatter x-ray system of claim 6, wherein the plurality of process tools comprise at least one of the following:
a spindle configured to rotatably drive a spindle tool for forming a hole in the structure;
a hole probe configured to measure at least one characteristic associated with a hole in the structure;
a fastener installer configured to install a fastener in a hole in the structure;
a coating applicator configured to apply a coating to the structure;
a touch-off probe configured to measure at least one characteristic associated with a fastener installed in the structure; and
a welding device for joining structural components.

8. The backscatter x-ray system of claim 6, wherein:
the end effector frame has a nose piece configured to be engaged to the frontside of the structure;
at least some of the process tools have a tool axis and are arranged in side-by-side relation to each other in the end effector frame and are movable along a shuttle axis perpendicular to the tool axes for one-at-a-time engagement with the nose piece; and
at least some of the process tools are movable along the respective tool axes between a retracted position in which a working end of the process tool is spaced apart from the structure, and an extended position in which the working end of the process tool is in close proximity to the structure.

9. A backscatter x-ray system, comprising:
an end effector frame configured to be mounted to a movable platform capable of positioning the end effector relative to a frontside of a structure;
a plurality of process tools mountable to the end effector frame and having different functional capabilities associated with hole formation and fastener installation in the structure;
an x-ray device mountable to the end effector frame adjacent to the process tools, and configured to emit x-rays that penetrate the structure from the frontside, and detect a backscatter of the x-rays reflected back from the structure; and
a processor configured to generate x-ray images based on the backscatter, and analyze the x-ray images in a manner detecting non-conformances in one or more aspects of at least one of a hole and a fastener installed in the hole.

10. The backscatter x-ray system of claim 9, wherein the processor is configured to analyze the x-ray images in a manner detecting one more of the following non-conformances in a fastener installation:
a non-conforming sleeve bulb on a tail end of a fastener;
a missing collar on a tail end of a fastener;
a non-conforming swage of the collar on the tail end of the fastener;
a missing receptacle on the tail end of a fastener;
a non-conforming installation of the receptacle on the tail end of the fastener;
a gap between a fastener head and the frontside of structure; and
a gap between a receptacle and a backside of structure.

11. The backscatter x-ray system of claim 9, wherein the plurality of process tools mounted to the end effector frame include comprise at least one of the following:
a spindle configured to rotatably drive a spindle tool for forming a hole in the structure;
a hole probe configured to measure at least one characteristic associated with a hole in the structure;
a fastener installer configured to install a fastener in the structure;
a coating applicator configured to apply a coating to the structure;
a touch-off probe configured to measure at least one characteristic associated with a fastener installed in the structure; and
a welding device configured to join structural components.

12. A method, comprising:
positioning, using a movable platform, an x-ray device relative to a frontside of a structure, the x-ray device having an x-ray emitter and an x-ray detector;
emitting, using the x-ray emitter, x-rays that penetrate the structure from the frontside;
detecting, using the x-ray detector, a backscatter of the x-rays reflected from the structure;
generating, using a processor, x-ray images of the structure based on the backscatter; and
analyzing, using the processor, the x-ray images in a manner facilitating at least one of manufacturing and inspection of the structure.

13. The method of claim 12, wherein analyzing the x-ray images comprises:
analyzing the x-ray images to detect inconsistencies in at least one of the following:
a fastener installation in the structure;
a sealant applied to the structure;
a coating applied to the structure;
a welding bead formed on the structure;
a material characteristic of the structure;
a material stackup of the structure; and
a gap between structural components of the structure.

14. The method of claim 12, wherein analyzing the x-ray images comprises:
comparing x-ray images of the structure to an as-designed model of the structure to detect non-conformances in the structure.

15. The method of claim 12, wherein positioning the x-ray device relative to the frontside of the structure comprises:
positioning the x-ray device such that a beam central axis of an x-ray beam defined by the x-rays is orientable according to at least one of the following:
parallel to a fastener centerline of a fastener installation in the structure;
non-parallel to the fastener centerline of the fastener installation;
locally perpendicular to a frontside surface of the structure; and
locally non-perpendicular to the frontside surface.

16. The method of claim 12, wherein positioning the x-ray device relative to the frontside of the structure comprises:
positioning the x-ray device using one of the following: a robotic device, a robotic arm, a machine, a CNC machine.

17. The method of claim 16, wherein positioning the x-ray device relative to the frontside of the structure comprises:
supporting the x-ray device and a plurality of process tools on an end effector frame of a multi-function end effector coupled to the movable platform.

18. The method of claim 17, wherein supporting the x-ray device and the plurality of process tools on the end effector frame comprises:
supporting the x-ray device and at least one of the following process tools on the end effector frame:
a spindle configured to rotatably drive a spindle tool for forming a hole in the structure;
a hole probe configured to measure at least one characteristic associated with a hole in the structure;
a fastener installer configured to install a fastener in a hole in the structure;
a coating applicator configured to apply a coating to the structure;
a touch-off probe configured to measure at least one characteristic associated with a fastener installed in the structure; and
a welding device for joining structural components.

19. The method of claim 18, wherein analyzing the x-ray images is performed in a manner facilitating adjusting of at least one of the following operating parameters of the process tools:
an advance rate of the spindle in driving the spindle tool into the structure;
a rotational speed of the spindle;
a travel speed of the coating applicator in applying the coating to the structure;
a travel path of the coating applicator in applying the coating to the structure;
a torque level applied to a fastener by the fastener installer; and
a travel speed of the welding device in forming a welding beam on the structure.

20. The method of claim 17, wherein analyzing the x-ray images is performed in a manner facilitating at least one of the following operations:
acquiring vision points in a substructure of the structure;
positioning a process tool relative to the vision points;
positioning a process tool on the frontside of the structure in alignment with a process tool on a backside of the structure;
positioning a hole pattern on the frontside of the structure based on a location of an edge in the substructure;
forming a hole in the structure;
inspecting the hole;
installing a fastener in the hole;
inspecting the fastener installed in the hole;
installing a sealant on the structure;
inspecting the sealant after installation;
applying a coating to the structure;
inspecting the coating after application;
forming a welding bead on the structure;
inspecting the welding bead; and
removing material from a frontside of the structure.
